(19) United States
(12) Patent Application Publication
(10) Pub. No.: US 2025/0297864 A1
(43) Pub. Date: Sep. 25, 2025

(54) ENHANCED NAVIGATION AND POSITIONING USING HYBRID SENSOR FUSION

(71) Applicant: QUALCOMM Incorporated, San Diego, CA (US)

(72) Inventors: Marko ANGJELICHINOSKI, San Diego, CA (US); Sony AKKARAKARAN, Poway, CA (US)

(21) Appl. No.: 18/609,395

(22) Filed: Mar. 19, 2024

(51) Int. Cl. G01C 21/36; G01C 21/34

(52) U.S. Cl. CPC G01C 21/3626; G01C 21/3415

(57) ABSTRACT

Disclosed are techniques for enhanced navigation; for example, of visually impaired persons, automated guided vehicles, etc. In an aspect, a network entity such as a server may obtain information indicative of a navigation environment and information indicative of an estimated traversal distance for a plurality of potential routes from an initial position of a wireless device to one or more locations proximate one or more target assets by obtaining image data from one or more cameras positioned to monitor one or more segments of the plurality of potential routes. The network entity may select a first route from the initial position of the wireless device to at least a first location of the one or more locations.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a network entity includes one or more memories; one or more transceivers; and one or more processors communicatively coupled to the one or more memories and the one or more transceivers, the one or more processors, either alone or in combination, configured to: obtain information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes; select a first route from the initial position of the wireless device to at least a first location of the one or more locations based at least in part on the information indicative of the navigation environment and the information indicative of the estimated traversal distance, the first location proximate a first target asset of the one or more target assets; and transmit, via the one or more transceivers, one or more navigation commands for the first route to the wireless device, one or more infrastructure devices, or a combination thereof.

In an aspect, a wireless device includes one or more memories; one or more transceivers; and one or more processors communicatively coupled to the one or more memories and the one or more transceivers, the one or more processors, either alone or in combination, configured to: communicate, via the one or more transceivers, with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; receive, via the one or more transceivers, at least a first navigation command indicative of a first route from the network entity, the first route including a plurality of route segments from an initial location of the wireless device to a target location, wherein the target location is based at least in part on at least a first target asset; and generate a first navigation instruction comprising haptic output, audio output, or both, the first navigation instruction determined based at least in part on a first navigation command.

In an aspect, a method of communication at a network entity includes obtaining information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes; selecting a first route from the initial position of the wireless device to at least a first location of the one or more locations based at least in part on the information indicative of the navigation environment and the information indicative of the estimated traversal distance, the first location proximate a first target asset of the one or more target assets; and transmitting one or more navigation commands for the first route to the wireless device, one or more infrastructure devices, or a combination thereof.

In an aspect, a method of communication at a wireless device includes communicating with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; receiving at least a first navigation command indicative of a first route from the network entity, the first route including a plurality of route segments from an initial location of the wireless device to a target location, wherein the target location is based at least in part on at least a first target asset; and generating a first navigation instruction comprising haptic output, audio output, or both, the first navigation instruction determined based at least in part on a first navigation command.

In an aspect, a network entity includes means for obtaining information indicative of a navigation environment and information indicative of an estimated traversal distance for a plurality of potential routes from an initial position of a wireless device to one or more locations proximate one or more target assets, wherein the means for obtaining information indicative of the navigation environment for the plurality of potential routes comprises means for obtaining image data from one or more cameras positioned to monitor one or more segments of the plurality of potential routes; means for selecting a first route from the initial position of the wireless device to at least a first location of the one or more locations based at least in part on the information indicative of the navigation environment and the information indicative of the estimated traversal distance, the first location proximate a first target asset of the one or more target assets; and means for transmitting one or more navigation commands for the first route to the wireless device, one or more infrastructure devices, or a combination thereof.

In an aspect, a wireless device includes means for communicating with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; means for receiving at least a first navigation command indicative of a first route from the network entity, the first route including a plurality of route segments from an initial location of the wireless device to a target location, wherein the target location is based at least in part on at least a first target asset; and means for generating a first navigation instruction comprising haptic output, audio output, or both, the first navigation instruction determined based at least in part on a first navigation command.

In an aspect, a non-transitory computer-readable medium stores computer-executable instructions that, when executed by a network entity, cause the network entity to: obtain information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes; select a first route from the initial position of the wireless device to at least a first location of the one or more locations based at least in part on the information indicative of the navigation environment and the information indicative of the estimated traversal distance, the first location proximate a first target asset of the one or more target assets; and transmit one or more navigation commands for the first route to the wireless device, one or more infrastructure devices, or a combination thereof.

In an aspect, a non-transitory computer-readable medium stores computer-executable instructions that, when executed by a wireless device, cause the wireless device to: communicate with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; receive at least a first navigation command indicative of a first route from the network entity, the first route including a plurality of route segments from an initial location of the wireless device to a target location, wherein the target location is based at least in part on at least a first target asset; and generate a first navigation instruction comprising haptic output, audio output, or both, the first navigation instruction determined based at least in part on a first navigation command.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates an example Long-Term Evolution (LTE) positioning protocol (LPP) capability transfer procedure, assistance data transfer procedure, and location information transfer procedure between a target device and a location server, according to aspects of the disclosure.

FIG. 6 shows an example navigation environment, according to aspects of the disclosure.

FIG. 7 shows an example server, according to aspects of the disclosure.

FIG. 8 shows an example process to navigate a Visually Impaired Person (ViP) at a site, according to aspects of the disclosure.

FIG. 9 shows an example process to retrieve target asset(s), according to aspects of the disclosure.

FIGS. 10 and 11 illustrate example navigation methods at a network entity and a wireless device, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to navigation; in particular to smart navigation of indoor spaces by Visually Impaired Persons (ViPs). In some aspects, a network entity such as a server is configured to manage navigation environment monitoring, positioning of persons and objects, detection and/or prediction of navigation impediments, and navigation of visually impaired persons along a route to one or more target assets. In some aspects, a wireless device is configurated to receive navigation commands and generate instructions for the ViP.

Particular aspects of the subject matter described in this disclosure can be implemented to realize one or more of the following potential advantages. In some examples, the disclosed strategies can enable safe and accurate navigation of ViPs through challenging navigation environments, even when the navigation environment changes while the ViP is traversing a site. In some examples, the disclosed strategies can enable accurate retrieval of one or more target assets positioned at the site. In some aspects, the techniques can use existing infrastructure, mitigating both cost and complexity of deployment.

Examples of the disclosed subject matter enable the use of different types of wireless devices and infrastructure. For example, the techniques may be implemented using a user-provided device and/or one or more site-provided devices, which may have integrated and/or associated camera(s), audio device(s), haptic capability, sensing capability, or a combination thereof. Examples of infrastructure devices can include vision systems, audio systems, radiofrequency (RF) systems, sensing systems, or a combination thereof.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

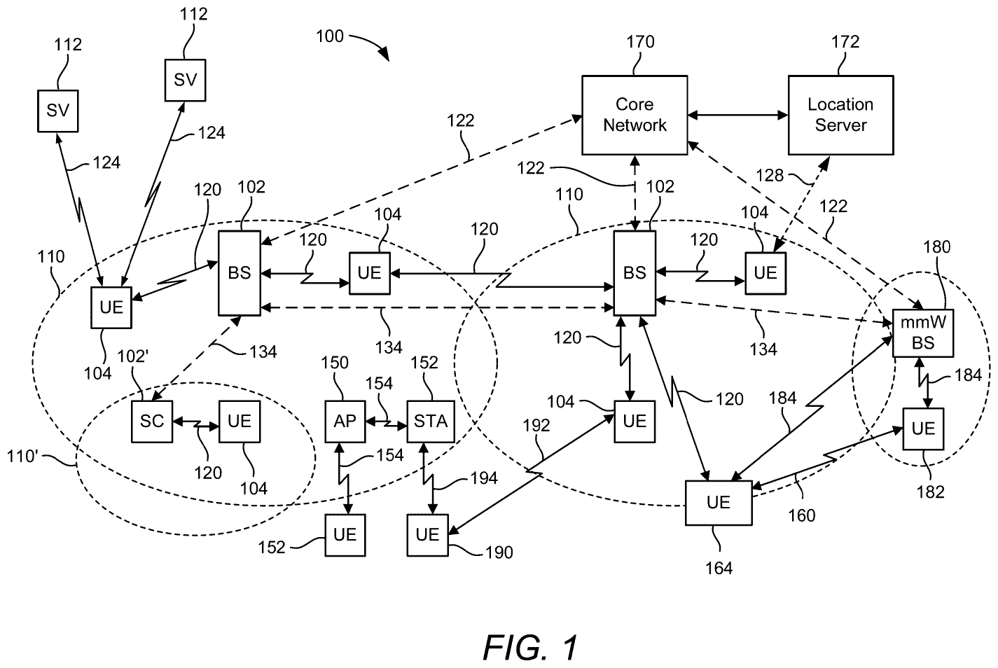

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other wireless devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

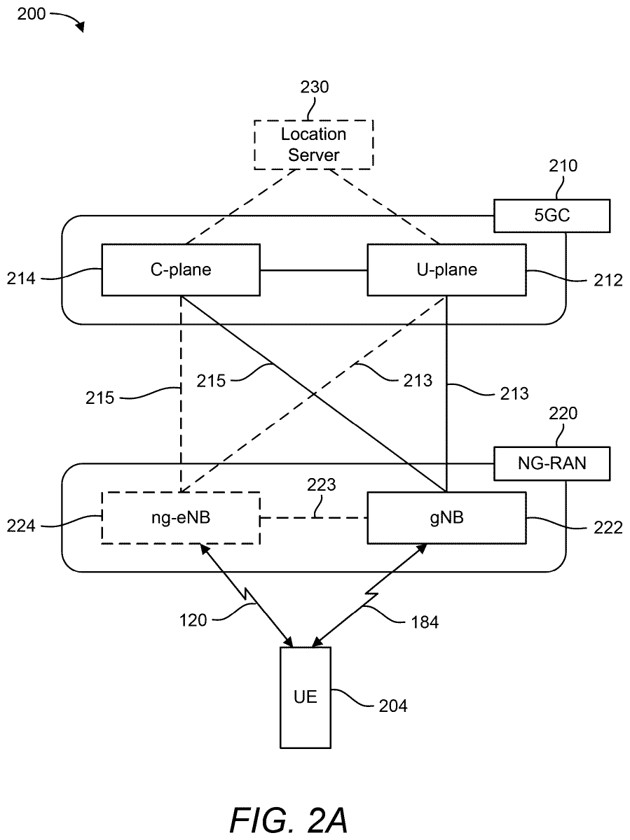

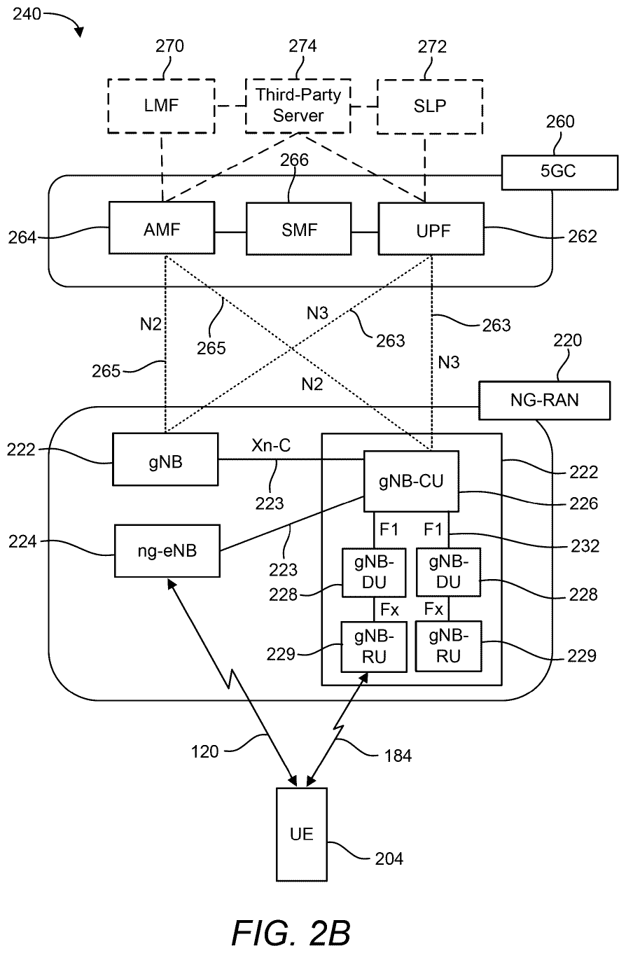

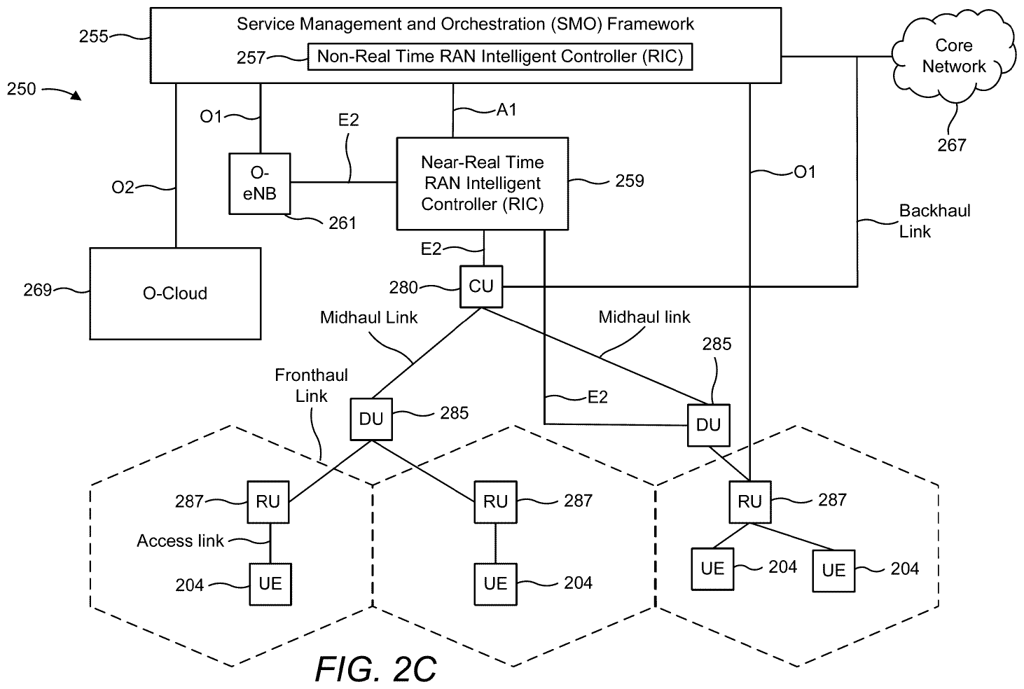

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

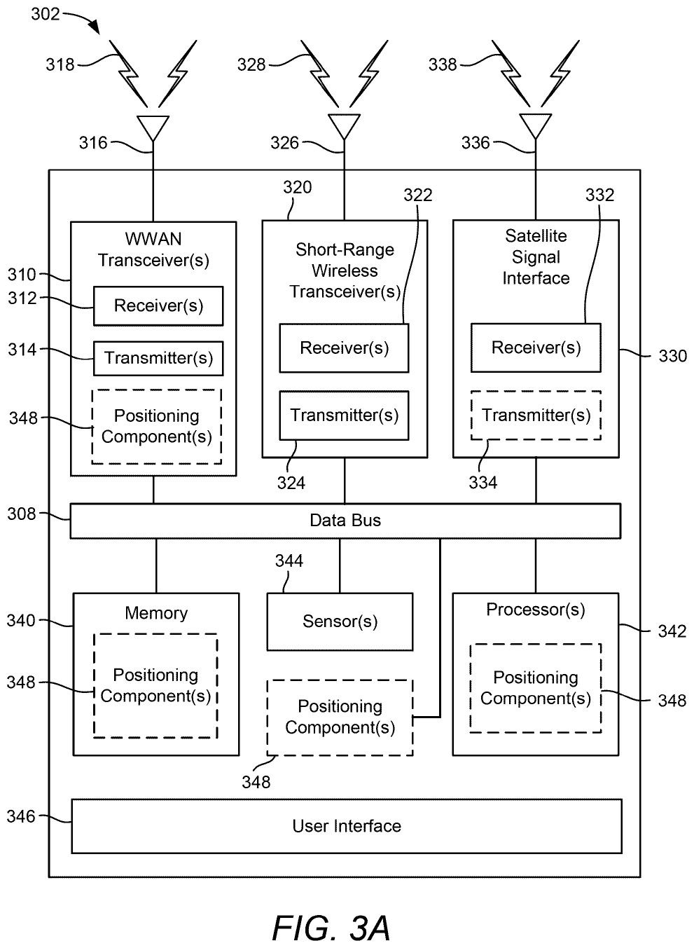

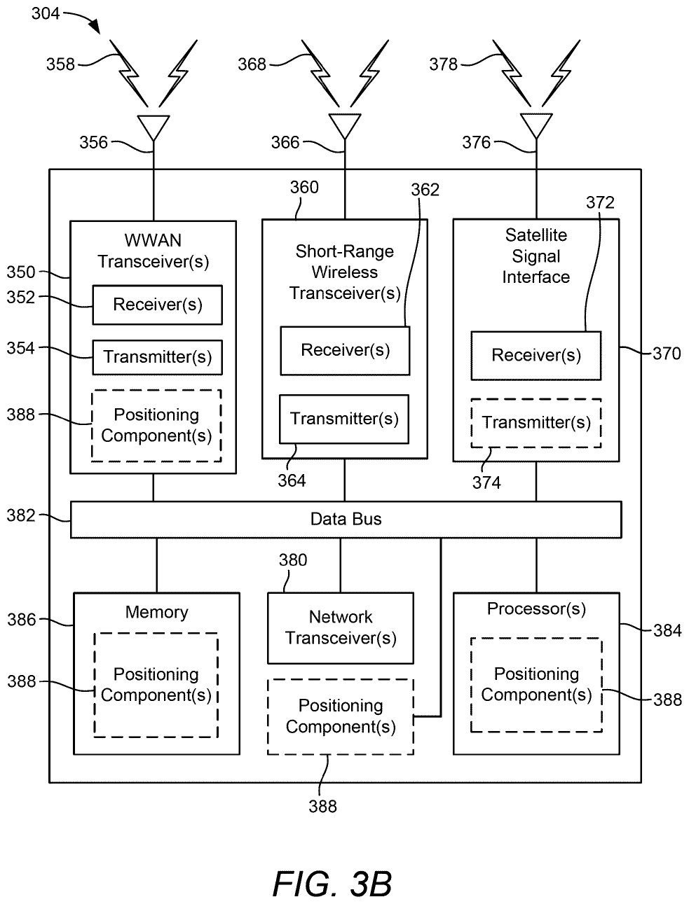

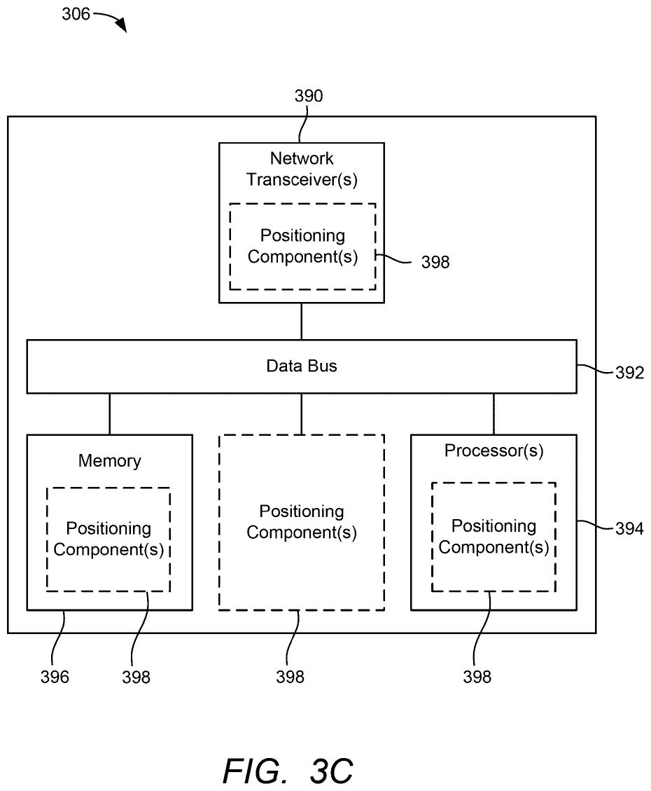

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component(s) 348, 388, and 398, respectively. The positioning component(s) 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning component(s) 348, 388, and 398 may be external to the processors 342, 384, and 394 (e.g., part of a modem processing system, integrated with another processing system, etc.). Alternatively, the positioning component(s) 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component(s) 348, which may be, for example, part of the one or more WWAN transceivers 310, the memory 340, the one or more processors 342, or any combination thereof, or may be a standalone component. FIG. 3B illustrates possible locations of the positioning component(s) 388, which may be, for example, part of the one or more WWAN transceivers 350, the memory 386, the one or more processors 384, or any combination thereof, or may be a standalone component. FIG. 3C illustrates possible locations of the positioning component(s) 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component(s) 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

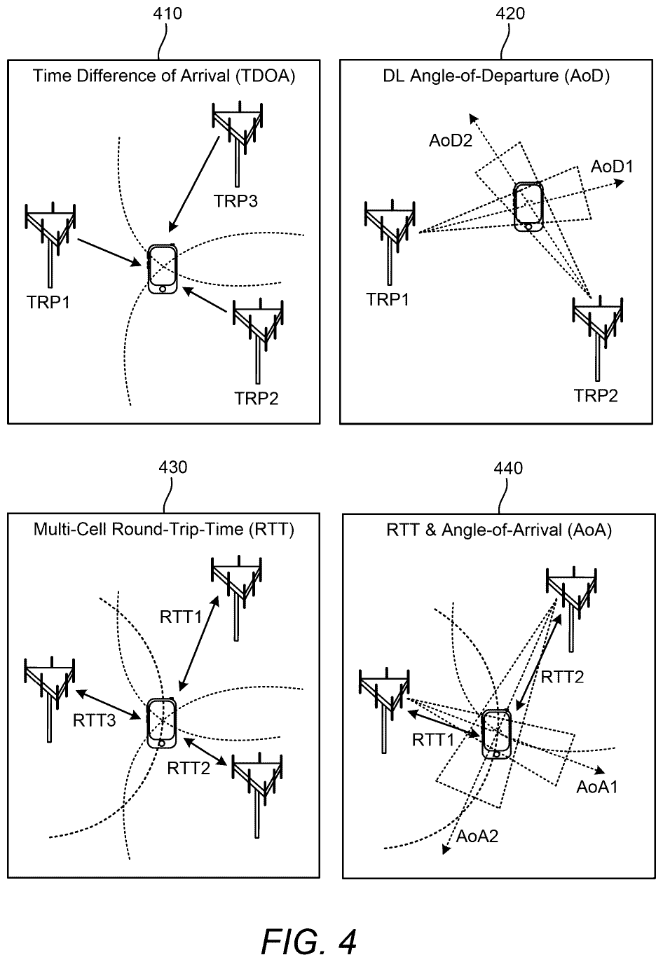

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

Long-Term Evolution (LTE) positioning protocol (LPP) is used point-to-point between a location server (e.g., LMF 270) and a target device (e.g., a UE) in order to position the target device using position-related measurements obtained by one or more reference sources (physical entities or parts of physical entities that provide signals that can be measured by a target device in order to obtain the location of the target device). An LPP session is used between a location server and a target device in order to obtain location-related measurements or a location estimate or to transfer assistance data. Currently, a single LPP session is used to support a single location request and multiple LPP sessions can be used between the same endpoints to support multiple different location requests. Each LPP session comprises one or more LPP transactions (or procedures), with each LPP transaction performing a single operation (capability exchange, assistance data transfer, or location information transfer). Each LPP transaction involves the exchange of one or more LPP messages between the location server and the target device. The general format of an LPP message consists of a set of common fields followed by a body. The body (which may be empty) contains information specific to a particular message type. Each message type contains information specific to one or more positioning methods and/or information common to all positioning methods.

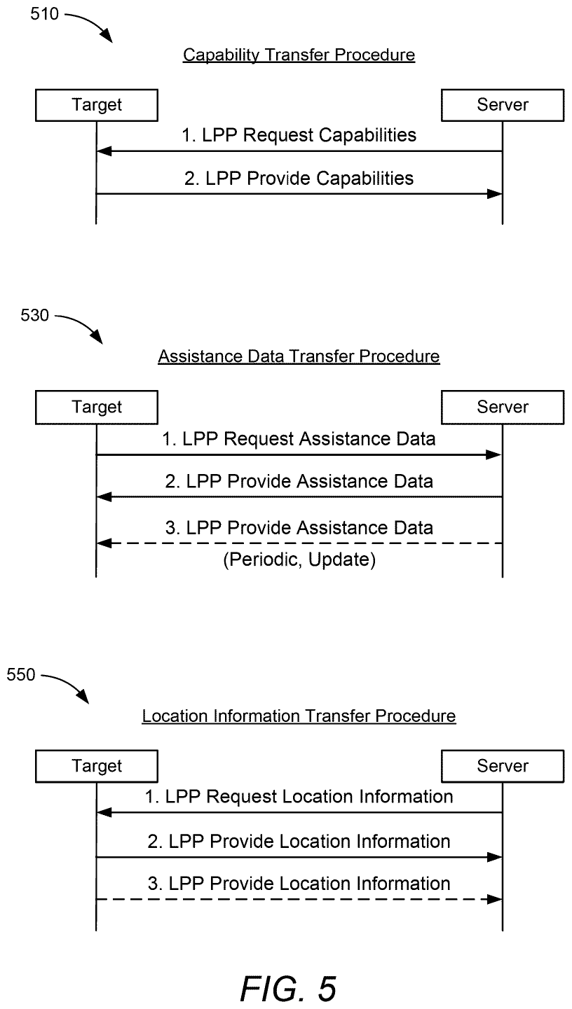

An LPP session generally includes at least a capability transfer or indication procedure, an assistance data transfer or delivery procedure, and a location information transfer or delivery procedure. FIG. 5 illustrates an example LPP capability transfer procedure 510, LPP assistance data transfer procedure 530, and LPP location information transfer procedure 550 between a target device (labeled “Target”) and a location server (labeled “Server”), according to aspects of the disclosure.

The purpose of an LPP capability transfer procedure 510 is to enable the transfer of capabilities from the target device (e.g., a UE 204) to the location server (e.g., an LMF 270). Capabilities in this context refer to positioning and protocol capabilities related to LPP and the positioning methods supported by LPP. In the LPP capability transfer procedure 510, the location server (e.g., an LMF 270) indicates the types of capabilities needed from the target device (e.g., UE 204) in an LPP Request Capabilities message. The target device responds with an LPP Provide Capabilities message. The capabilities included in the LPP Provide Capabilities message should correspond to any capability types specified in the LPP Request Capabilities message. Specifically, for each positioning method for which a request for capabilities is included in the LPP Request Capabilities message, if the target device supports this positioning method, the target device includes the capabilities of the target device for that supported positioning method in the LPP Provide Capabilities message. For an LPP capability indication procedure, the target device provides unsolicited (i.e., without receiving an LPP Request Capabilities message) capabilities to the location server in an LPP Provide Capabilities message.

The purpose of an LPP assistance data transfer procedure 530 is to enable the target device to request assistance data from the location server to assist in positioning, and to enable the location server to transfer assistance data to the target device in the absence of a request. In the LPP assistance data transfer procedure 530, the target device sends an LPP Request Assistance Data message to the location server. The location server responds to the target device with an LPP Provide Assistance Data message containing assistance data. The transferred assistance data should match or be a subset of the assistance data requested in the LPP Request Assistance Data. The location server may also provide any not requested information that it considers useful to the target device. The location server may also transmit one or more additional LPP Provide Assistance Data messages to the target device containing further assistance data. For an LPP assistance data delivery procedure, the location server provides unsolicited assistance data necessary for positioning. The assistance data may be provided periodically or non-periodically.

The purpose of an LPP location information transfer procedure 550 is to enable the location server to request location measurement data and/or a location estimate from the target device, and to enable the target device to transfer location measurement data and/or a location estimate to a location server in the absence of a request. In an LPP location information transfer procedure 550, the location server sends an LPP Request Location Information message to the target device to request location information, indicating the type of location information needed and potentially the associated QoS. The target device responds with an LPP Provide Location Information message to the location server to transfer location information. The location information transferred should match or be a subset of the location information requested by the LPP Request Location Information unless the location server explicitly allows additional location information. More specifically, if the requested information is compatible with the target device's capabilities and configuration, the target device includes the requested information in an LPP Provide Location Information message. Otherwise, if the target device does not support one or more of the requested positioning methods, the target device continues to process the message as if it contained only information for the supported positioning methods and handles the signaling content of the unsupported positioning methods by LPP error detection. If requested by the LPP Request Lactation Information message, the target device sends additional LPP Provide Location Information messages to the location server to transfer additional location information. An LPP location information delivery procedure supports the delivery of positioning estimations based on unsolicited service.

LPP also defines procedures related to error indication for when a receiving endpoint (target device or location server) receives erroneous or unexpected data or detects that certain data are missing. Specifically, when a receiving endpoint determines that a received LPP message contains an error, it can return an Error message to the transmitting endpoint indicating the error or errors and discard the received/erroneous message. If the receiving endpoint is able to determine that the erroneous LPP message is an LPP Error or Abort Message, then the receiving endpoint discards the received message without returning an Error message to the transmitting endpoint.

LPP also defines procedures related to abort indication to allow a target device or location server to abort an ongoing procedure due to some unexpected event (e.g., cancellation of a location request by an LCS client). An Abort procedure can also be used to stop an ongoing procedure (e.g., periodic location reporting from the target device). In an Abort procedure, a first endpoint determines that procedure P must be aborted and sends an Abort message to a second endpoint carrying the transaction ID for procedure P. The second endpoint then aborts procedure P.

In some environments, smart navigation tools can enable more efficient and accurate navigation among locations. For example, in some indoor industrial Internet of Things (IoT) environments, space efficiency can lead to maze-like layouts, while organizational efficiency can lead to self-similar appearance of objects in proximity to one another. Smart navigation tools may be beneficial in challenging environments like these, where traditional navigation may be error prone and time intensive.

Navigation can be particularly challenging for persons with disabilities. Some existing smart navigation solutions are enhanced to support users with physical impairments and other disabilities. Although these solutions can improve the ability of disabled persons to participate in activities of their choice, in many cases they fail to support full participation. One challenging aspect of supporting persons with disabilities is that different support may be needed in different environments, and may differ significantly for different disability types and level of disability. As a result, solutions that attempt to address several disabilities with a single technical solution may provide good support for one person in one environment and poor support for others.

Some dedicated disability-friendly technologies are available and include, for example, dedicated multi-sensor devices, smart canes, and solutions based on audio/acoustic technologies. Although these technologies can assist visually impaired persons, in many circumstances the support is insufficient, For example, available devices can enable visually impaired persons to detect impediments to navigation as they traverse a site but fail to support the ViP in finding an alternate route to a destination. For example, a smart cane can alert a ViP of an object in front of the person so they can avoid a collision with the object, but if the ViP needs to deviate from the known path he or she may require assistance to navigate to their destination. As a result, the ViP may have difficulty performing everyday activities like shopping, working, and recreation without assistance.

Aspects of the current disclosure include systems and techniques that can enable visually impaired persons to navigate sites safely and efficiently. In some implementations, available technologies for on-site infrastructure (e.g., RF, vision, sensor, and/or audio systems) can be used for the navigation and retrieval techniques described herein. In some examples, available infrastructure can be augmented with additional tools to provide enhanced navigation specifically directed to visual disability; for example, smart off-the-shelf infrastructure or user-based technology. In some aspects, the techniques can be used with Automated Guided Vehicles (AGVs) to navigate a site to retrieve objects and/or perform other operations.

For example, a ViP may find it difficult to navigate a large retail store with many aisles and shelves, and with visually similar items shelved proximate to one another. Aspects of the disclosure provide techniques that a ViP can use to navigate the site in a safe way, retrieve one or more target assets from shelving or other placement (e.g., even if the target assets are located proximate to other similar assets), and navigate to a payment location and/or store exit.

Implementations that use at least some existing legacy infrastructure at a site may provide a cost-effective way of providing support for smart navigation, with reduced complexity of deployment. For example, some sites implement hybrid multiple target tracking and positioning tools for smart navigation, while some sites use infrastructure as part of a monitoring and surveillance system to manage inventory and deter theft. Aspects of the current disclosure can use existing infrastructure for navigation of ViPs, in an energy efficient manner and with limited or no interference with the operation of legacy applications.

Some examples of existing infrastructure include technological components such as radio-frequency (RF) devices (e.g., servers, access points, WiFi devices, Electronic Shelf Label-Bluetooth Low Energy (ESL-BLE) technology, Ultra Wideband (UWB) technology, etc.), vision-related devices (e.g., closed circuit television (CCTV) cameras deployed across ceilings, aisles, shelves, etc., ShelfCams, handheld/UE cameras, etc.), and audio devices (e.g., Public Address (PA) speakers, UE microphones, etc.).

An enhanced navigation system including deployment of additional infrastructure and/or wireless devices can increase the effectiveness of smart navigation for some sites. Examples of additional/different infrastructure devices may include additional CCTV cameras positioned to facilitate the described techniques (e.g., in poor visibility areas, such as aisles and even between shelves), additional dedicated PA speakers and/or microphones deployed more densely across the aisles, increased number of ESLs for denser deployments, and floor sensors that can sense persons and objects and/or interact with devices such as smart canes, AGVs, etc.

Examples of user and/or site-provided wireless devices include smart canes, specialized hearing aids, headphones, earbuds, or the like that may communicate with dedicated specialized speakers, specialized store-provided devices for the visually-impaired, etc. Since it is common for elderly persons to be both visually impaired and have limited mobility, in some cases wireless devices may be integrated with or configured to be mounted on a mobility device such as a cane, walker, wheelchair, or motorized mobility cart. Additionally, since some visually impaired persons have some sight, wireless devices and/or infrastructure devices can provide visual cues to be used with audio output and haptic output for communication of navigation instructions. The visual cues may be larger, brighter, simpler, and/or have other characteristics that make them more easily decoded by ViPs with some sight.

According to aspects of the current disclosure, a network entity such as a server can obtain information indicative of a navigation environment at the site, as well as positioning information for a ViP, AGV, or other device being navigated, as well as other persons/objects at the site. Additionally, the server has or obtains information indicative of traversal distance for potential routes through the site; for example, the server may store map information for pedestrian-navigable route segments at the site, where the map information includes a length of the route segment, an effective width of the route segment, and/or other site parameters that the server can use to estimate traversal distances/times for potential routes through the site. The navigation environment refers to the status of the pedestrian-navigable route segments (e.g., aisles, portions of aisles, paths around a display table, etc.); for example, the existence and placement of navigation impediments such as obstructions, hazards, congestion, and the like along the possible paths through the site.

The information indicative of the navigation environment can be obtained using infrastructure devices, wireless devices, or a combination thereof, and communicated to the server. Additionally, position information for wireless devices, persons, and other objects can be obtained using RF positioning techniques, vision positioning techniques, sensing techniques, and/or audio positioning techniques, and sent to the server. Based on obtaining information indicative of a navigation environment and an estimated traversal distance/time for a plurality of potential routes from an initial position to one or more locations proximate the one or more target assets of the target asset list, the server can determine a first route to one or more of the target assets. Note that estimates of traversal time are indicative of estimated traversal distance, since the two parameters are related by the speed of the ViP. The server can transmit navigation command(s) sequentially to a wireless device and/or one or more infrastructure devices. For navigation of a ViP, the navigation commands are used to generate navigation instructions for the ViP to use to navigate the site to a first location proximate a first target asset. Note that for target asset retrieval, the system may have a proximity measure that is quite large; the ViP should be close enough to the target asset so the retrieval process can be used to allow the ViP to retrieve the asset, but in many cases the location (e.g., the first location) need not be defined with much precision, and proximity can encompass a relatively wide range of distance. For example, in some cases the ViP can be navigated to the particular aisle where the target asset is located, and the retrieval process can direct the ViP to the precise target location.

The server can monitor the navigation environment while a navigated entity is traversing the route and, if indicated, determine a different route. For example, if the server detects one or more conditions indicating the current route should be re-evaluated (e.g., if a route segment becomes impeded, if a ViP executes the navigation instructions incorrectly, if an AGV unexpectedly slows or stops, or if an item is added to or deleted from a target asset list), the server may determine whether a route correction or route recalculation is indicated. If so, the server can update the route accordingly. Once the ViP reaches the first location proximate the first target asset, the server can localize the position of the first target asset relative to the ViP and generate navigation commands for the ViP to retrieve the first target asset.

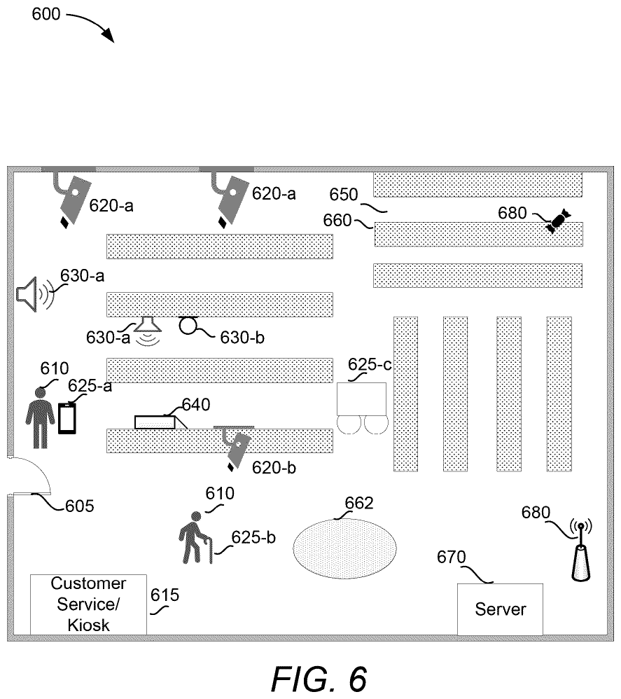

FIG. 6 shows an example navigation environment 600, according to some aspects of the disclosure. Navigation environment 600 may be a retail establishment, a warehouse, a manufacturing facility, or other type of site that may be navigated by a ViP. Environment 600 is accessed through an entrance door 605, and products (including at least one target asset 680) are presented on shelves 660 and a display table 662. Shelves 660 are accessed by navigating environment 600 using aisles 650 and/or areas of open space (e.g., the open areas around a display table 662). A ViP 610 may have a user wireless device 625 such as smartphone 625-a, or may acquire a wireless device at the site. For example, a ViP 610 can acquire a site-provided smart cane 625-b at a customer service desk/self-service kiosk 615. In some aspects of the disclosure, an automated guided vehicle (AGV) 625-c may also navigate environment 600, referred to herein as a user device. An AGV 625-c may be associated with the site (a type of site-provided wireless device) or may be associated with an external entity such as an individual, an automated shopper service provider, etc. (a type of user wireless device). AGV 625-c may include RF systems, vision systems, audio systems, sensor systems, automated retrieval systems, etc.

Environment 600 includes a number of example devices that can be used in aspects of the disclosure. Examples of one or more vision devices can include infrastructure vision devices and/or user vision devices. Vision devices can include infrastructure cameras such as wall-mounted or ceiling-mounted closed circuit television (CCTV) cameras 620-a, and/or shelf-mounted cameras 620-b. The vision devices can include one or more user cameras; for example, camera(s) in communication with/integrated with a personal or site-provided wireless device 625, or a combination. User vision devices integrated with AGV 625-c may include cameras to provide image data (raw and/or processed) from a number of directions; for example, in navigation directions (e.g. horizontal), as well as cameras providing a view above AGV 625-c and/or below AGV 625-c (for an example environment incorporating floor sensing). In some examples, CCTV cameras 620-a may be always-on, while shelf-mounted cameras 620-b may be activated on-demand.

Examples of one or more audio devices can include infrastructure audio devices and/or user audio devices. Infrastructure audio devices can include speakers and microphones, such as shelf, wall, and/or ceiling mounted speakers 630-a and/or microphones 630-b, some of which may be included in a public address (PA) system. In some implementations, user audio devices may include speakers and/or microphones integrated with a smart cane 625-b, headphones, hearing aids, ear buds, etc. (not shown), while in some cases user audio devices may be integrated with a user or site-provided wireless device 625, such as smart phone 625-a or AGV 625-c.

In some implementations, at least some of the audio devices 630 can communicate using audio-based signaling, such as signaling that uses frequencies in the upper part of the hearable range and/or just beyond the hearable range. Herein, “audio” refers generally to sound signals, both within hearable frequency range and extending outside the hearable range. In an example, a user or site-provided wireless device can include a microphone, and navigation commands can be delivered using infrastructure speakers 630-a. The speakers may use audio signals just above the audible range where orthogonalization can be relatively easily achieved. For example, if a ViP has a smart cane 625-b with a microphone, the smart cane may receive navigation commands over the audio interface and parse the commands into navigation instructions using haptic output such as mechanical vibrations in the cane with varying frequencies that modulate path information for the ViP; effectively, a mechanical braille code.

Examples of one or more RF devices can include infrastructure RF devices and/or RF-capable wireless devices. Examples of infrastructure RF devices 640 can include BLUETOOTH® devices such as Electronic Shelf Label-BLUETOOTH® Low Energy (ESL-BLE) devices, RFID devices, and WiFi devices. Examples of RF-capable wireless devices 625 include wireless devices such as smart phones 625-a, smart canes 625-b, specialized wireless devices for the visually impaired, etc. (not shown). For example, when a ViP is equipped with a wireless device such as a smart cane with low power, low bandwidth radio, navigation commands can be delivered over the radio interface and communicated to the ViP with mechanical vibrations as described above.

In some aspects of the current disclosure, environment 600 may include a floor and/or shelf sensing system (not shown). A floor sensing system may include one or more sensors to detect a ViP and/or a wireless device. Floor sensing may be performed using vision device(s), acoustic device(s), RF device(s), and sensor device(s) such as pressure sensors. In some aspects of the disclosure, a floor sensing system may also be configured to communicate navigation instructions to a ViP. For example, the floor system can signal navigation instructions using RF components, audio components, haptic components, vision components, etc. For a ViP with some vision, a floor system may be configured to generate visual signals. Shelf sensing may include weight sensors on one or more shelves to enable accurate retrieval of one or more target assets. In an example aspect, a floor sensing system may include a pressure sensor array to detect and monitor the position of the ViP as they traverse a route through the site and may monitor the positions and movement of other users to detect congestion, predict future congestion or collisions. The floor sensing system may include RF elements to provide the sensor-based information to a network entity such as a server 670, and/or to communicate sensor-based information to infrastructure to generate navigation instructions to the ViP. In implementations including an AGV 625-c, sensing systems may be used to monitor a position of AGV 625-c, to communicate navigation commands to AGV 625-c, etc.

Environment 600 may further include one or more access points 680; for example, to enable WiFi, BLUETOOTH®, or other communications between infrastructure devices and/or wireless devices and one or more servers 670. Server(s) 670 may include memory circuitry and processor circuitry to store and execute instructions to implement the disclosed techniques. For example, server(s) 670 may communicate with one or more infrastructure devices and/or one or more wireless devices to monitor a navigation environment of a site, determine navigation commands/instructions for one or more wireless devices/ViPs to navigate to one or more locations associated with target asset(s), and update the navigation commands/instructions if needed (e.g., based on predicted and/or detected navigation impediments). Server 670 may include map information for pedestrian-navigable route segments at the site, where the map information includes a length of the route segment, an effective width of the route segment, etc., which the server can use to compare relative traversal distances/times for potential routes through the site and use to determine navigability of potential routes. A “route segment” used herein refers to a navigable portion of the site that can be used to navigate the ViP through the site when included in a route, but the system need not explicitly define route segments in performing the techniques herein. In an example, route segments may extend across open spaces and along aisles and have ends that are either a terminal end (such as store entrance/exit, area entrance/exit, end of an aisle, etc.) or a branching node where multiple possible paths branch from the current segment. In some cases a route segment can be directional; for example, navigating an aisle segment in a forward or reverse direction or navigating around an object such as a table in an open space in a clockwise or counterclockwise direction can be considered different route segments.

In an example implementation, a Visually Impaired Person (ViP) 610 is navigated to a target asset 680, included on a target asset list for the ViP. In one aspect of the disclosure, the ViP is navigated to a location proximate target asset 680; for example, within a threshold distance of target asset 680. According to aspects of the disclosure, navigation routes can be dynamically updated to avoid navigation impediments such as hazards, occlusions, and congestion that may occur or resolve while the ViP is traversing a current route. In another aspect of the disclosure, the ViP is directed towards the correct product for retrieval. These aspects are described in greater detail below.

In an example in which an AGV 625-c is configured to retrieve one or more target assets, AGV 625-c is navigated to a target asset 680. In one aspect of the disclosure, AGV 625-c is navigated to a location proximate target asset 680; for example, within a threshold distance of target asset 680. According to aspects of the disclosure, navigation routes can be dynamically updated to avoid navigation impediments such as hazards, occlusions, and congestion that may occur or resolve while the AGV 625-c is traversing a current route. In another aspect of the disclosure, AGV 625-c is directed towards the correct product for retrieval.

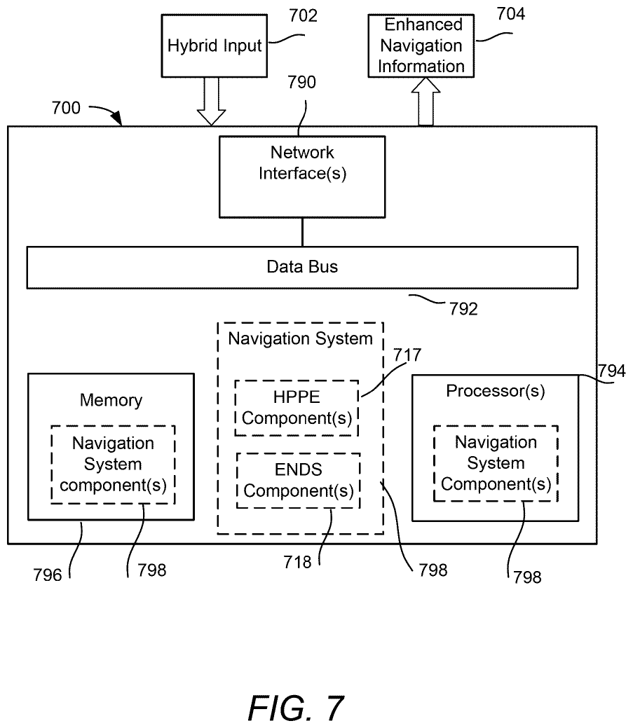

FIG. 7 shows an example network entity, according to aspects of the disclosure. A network entity such as a server 700 may include one or more network interfaces 790 to communicate with other devices such as wireless devices and infrastructure devices; for example, to receive hybrid input 702 and transmit enhanced navigation information 704. Server 700 may be a local server or a server associated with a navigation service provider and located elsewhere. The one or more network interfaces 790 may include a wireless network interface including one or more transceivers to wirelessly communicate with other devices (e.g., via one or more access points). The one or more network interfaces may further include wired interface(s) to communicate with infrastructure or other devices using wired connections. Server 700 includes navigation system component(s) 798, which may include hybrid processing and positioning engine (HPPE) component(s) 717 and enhanced navigation for disability support (ENDS) component(s) 718. Memory circuitry is 796 is configured to store instructions and data, including instructions and data for navigation system 798. Processor circuitry 794 is configured to execute instructions, including instructions for navigation system 798. Although shown separately in FIG. 7, memory 796, navigation system 798, and processor circuitry 794 may be included in one or multiple hardware modules, may share at least some circuitry and functionality, and may perform other functions in addition to those discussed herein. Server 700 includes a data bus 792 in communication with network interface 790 to communicate information among network interface 790 and processor circuitry 794, memory circuitry 796 and navigation system 798.

In some aspects, navigation system 798 includes HPPE Component(s) 717 and ENDS Component(s) 718. HPPE component(s) 717 implement at least some positioning functionality; for example, HPPE component(s) 717 can execute instructions and store instructions and data to manage device and system input for positioning, and to use the input to determine locations of persons, devices, objects, hazards, etc. ENDS component(s) 718 implement navigation techniques for ViPs. HPPE component(s) 717 and ENDS component(s) 718 are shown as separate modules in FIG. 7, but in general are interdependent and can be implemented with at least some overlapping data, instructions, and circuitry. For example, HPPE component(s) 717 may receive information from infrastructure and wireless device visual systems, audio systems, sensors, RF systems, or a combination and generate position information for ViPs, target assets, other users and objects, and actual and potential hazards at the site. ENDS component(s) 718 can use position information from HPPE component(s) 717 to compare potential routes based on estimated traversal distances/times for the potential routes and the position of existing and/or predicted navigation impediments, select a route, and generate navigation commands for transmission to wireless device(s) and/or infrastructure device(s). HPPE component(s) 717 can generate the commands based on a navigation command codebook that may account for capability of a wireless device to generate accurate navigation instructions, availability of infrastructure devices to generate accurate navigation instructions, etc. The navigation commands can be used by the wireless device and/or infrastructure to generate navigation instructions for a ViP as they traverse the selected route.

Implementations described herein can provide techniques for targeted navigation; that is, navigating a ViP from a start location to target location(s) proximate the placement of the target asset(s). Additionally, techniques for final target asset localization and retrieval are described. For example, the techniques can enable the ViP to recover the correct asset once navigation proximate its location is successful. The current disclosure provides techniques that allow a ViP to navigate one or more locations to retrieve target asset(s) in a safe, accurate, and timely manner. Further, the techniques allow for efficiency; e.g., the techniques are cost- and energy-efficient while providing safety, accuracy, and timeliness. In other implementations, a wireless device of an AGV can receive the navigation instructions to navigate to one or more target assets and/or to navigate to a location for performing one or more other operations such as reducing/removing navigation impediment(s) for safer navigation of a site.

In some aspects of the disclosure, a list of target assets may be provided to the system prior to arriving at the site or may be provided as part of an initial registration process at the site. The system can select a first route from one or more potential routes based on the list of target assets, a set of locations of the asset(s) at the site and an initial location of the ViP, estimated traversal time(s) for each of the potential routes, information related to the navigation environment at the site, and/or other relevant information. Navigation commands for the first route are sent to a wireless device and/or one or more infrastructure devices, which are used to generate one or more navigation instructions, which are communicated to the user with audio output and/or haptic output as the user traverses the first route (and optionally visual guidance, for ViPs that have some vision). In an implementation in which an AGV is navigated, navigation commands can be received by the AGV to navigate the site.

The navigation environment may be monitored using infrastructure devices and/or wireless devices associated with the user and/or other users at the site. If a condition for evaluating the route occurs, the system can determine whether a correction or route recalculation is needed, and if so can generate updated navigation commands based on the new or corrected route. Example conditions for evaluating the route include a change in the target asset list, a detection of user error in executing navigation instructions, or a change in the navigation environment (such as the detection or prediction of a navigation impediment or resolution of a previous navigation impediment). Once the user navigates to a position proximate to an asset location, the system may generate further instructions using audible output and/or haptic output to locate the asset itself. For additional target assets, the above may be performed multiple times.

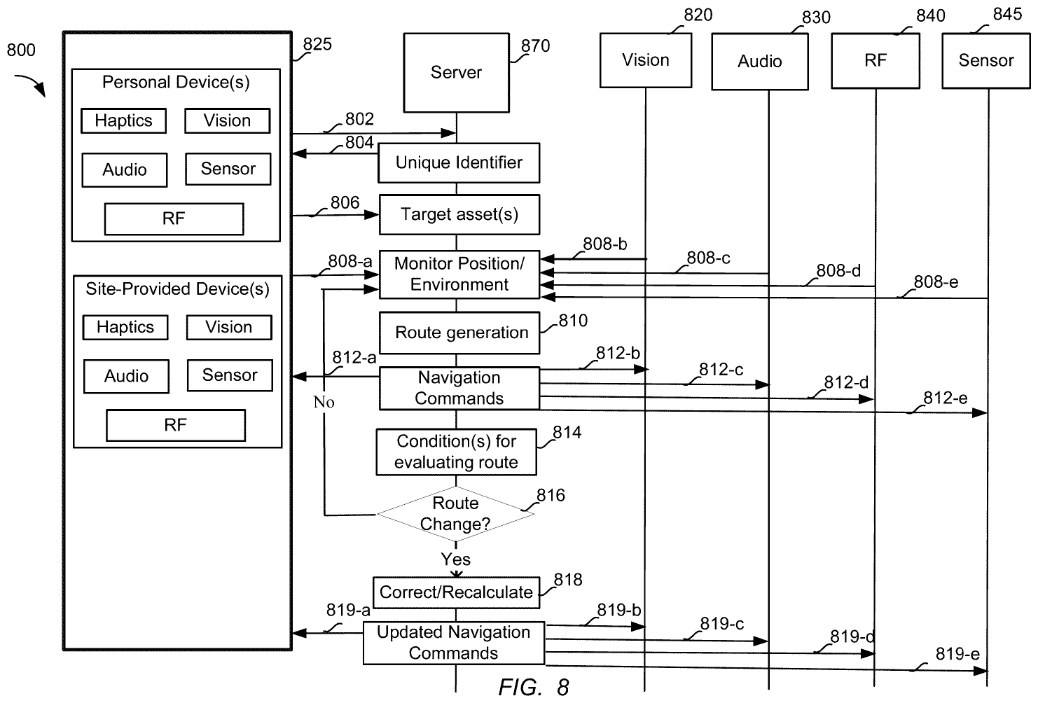

FIG. 8 illustrates an example system and process 800 for navigation of a site, according to some aspects of the current disclosure. The site may have one or more servers 870 to manage navigation (e.g., such as server 670 of FIG. 6), an infrastructure vision system 820 to obtain image data at the site and optionally generate visual signals, an infrastructure audio system 830 to obtain audio data and/or generate audio signals (in the hearable range and/or above the hearable range), an infrastructure RF system 840 to generate or obtain RF data and/or RF signals, an infrastructure sensor system 845 such as a floor sensor system and/or a shelf sensor system, or a combination thereof. Image data may be raw data obtained by one or more cameras, pre-processed data based on the raw data, partially or fully processed computer vision data (e.g., detected objects, classified objects, identified objects, etc.).

A ViP may have one or wireless devices 825, which can be user wireless devices and/or site-provide wireless devices. A wireless device can be a general use device such as a smart phone or a special purpose device such as a smart cane, smart mobility device, or specialized device for the visually impaired. The wireless device(s) can provide RF, visual, audio, and haptic capability. For example, a wireless device 825 can be an RF-capable device such as a smartphone that can communicate with infrastructure devices and server 870 using WiFi, cellular, and/or other RF communication interfaces. An RF-capable smartphone may include integrated microphone(s), speaker(s), camera(s), and/or vibration motors/actuators to provide haptic capability. A wireless device 825 can include other types of devices such as headphones, hearing aids, microphones, and/or external camera devices, which can be used as stand-alone devices or in communication with an RF-capable device such as a smartphone. Locally connectable devices may be configured to communicate with an RF-capable wireless device using a local protocol such as BLUETOOTH®. In some aspects, wireless device 825 can be an AGV with integrated RF, visual, and audio capability, and can communicate with infrastructure devices and network entities using WiFi, cellular, and/or other RF communication interfaces. In some aspects, an AGV can also communicate using audio signaling, visual signaling, and/or haptic signaling.

A site may also include additional devices, such as a customer service desk/self service kiosk, and one or more access nodes to provide communication among the one or more servers, infrastructure device(s), and wireless device(s).

A ViP may use a wireless device 825 (such as a user device or a site-provided device), site infrastructure, or some combination to navigate the site to retrieve one or more target assets safely, accurately, and within a reasonable time. In an example where the ViP does not have a wireless device, server 870 may use information received from infrastructure devices and/or other devices at the site to determine the ViP position, monitor the navigation environment for predicted or actual navigation impediments, and provide navigation commands to infrastructure devices to generate navigation instructions for the ViP. Similarly, an AGV can navigate the site to retrieve one or more target assets and/or perform other operations at the site.

Prior to beginning navigation, a ViP either initiates the process on a user wireless device 825 or using a customer service function or self-service kiosk at the site. A ViP without a device may obtain a site-provided wireless device 825 from an employee or using the self-service kiosk. In some aspects, an on-site AGV need not perform at least some initialization operations, while an AGV associated with an external entity such as an individual, an automated shopper service provider, or other entity may initiate a navigation process at the site.

At 802, the navigation process is initiated with the system; for example, to enable retrieval of one or more target assets at a site with smart navigation capability. Initiation of the navigation process may include an indication that the navigation is for a visually impaired person; for example, an explicit indication of a disability type and/or extent of visual impairment provided on a web site or smartphone application, an inherent indication associated with interaction with a particular smartphone application for navigation of ViPs, or an indication provided when initiating service for smart navigation of ViPs at a customer service function/kiosk. For implementations in which the ViP has an RF-capable wireless device 825 (either user or site-provided), wireless device 825 may connect with server 870. Wireless device 825 can connect to server 870 automatically or a user or customer service person can initiate or confirm server connection. Using the server connection, the UE can send data messages, and reports; receive instructions and control messages; and perform other actions related to smart navigation at the site. For a site-provided wireless device 825, registration and identifier association may be performed with customer service or at a self-service kiosk.

At 804, server 870 may associate the ViP with an identifier; for example, an identifier sufficient to differentiate entities active in the system (e.g., a globally or locally unique identifier). As part of the initialization process, wireless device 825 may provide information such as a UE MAC address, device battery status, RF status, etc., and the system may store information provided by wireless device 825. In some aspects, a MAC address associated with the wireless device may be a virtual identifier that dynamically changes for the wireless device, while in some aspects a MAC address may be a physical address of the wireless device. For example, information associated with wireless device 825 can be parsed into a unique database entry with accompanying identifiers across multiple device Application Programming Interfaces (APIs). In some aspects, an on-site AGV may be identified in the system when initially deployed at the site, while an AGV from an external entity may be assigned an identifier and be associated with a database identifier.

In some cases, a ViP with limited technological ability or with limited means may not have a user wireless device configured to perform the described techniques. In another example, a person may have a user wireless device but with insufficient capability or with a depleted battery. In order to support ViPs without a personal (user) wireless device, the site may provide a wireless device, or may use infrastructure devices to support smart navigation at the site. In this case, a ViP may enter the site and engage an employee, engage with a self-service kiosk, or engage with other automated system tools to initiate the smart navigation process. For example, the ViP may have an account associated with the site or with a smart navigation entity and may initiate the smart navigation process using account credentials, a card associated with an account, or by providing an employee with identification information.

Examples of site-provided wireless devices include smart canes, special-use mobile devices (e.g., that can be carried or attached to a cane, cart, wheelchair, walker, etc.), mobility carts with an integrated smart navigation device, headphones, ear buds, haptic generators, etc. An example is a smart cane equipped with dedicated pressure/weight/light/radio sensor which can then be reliably tracked using a dedicated sensor networks deployed on the floor. In some implementations, a personal or site-provided smart cane may also have a low-grade mic or low bandwidth, short-range radio for additional navigation capabilities. Another example of a site-provided device is a visually-distinguishable object such as a cane (e.g., in unique color, shape etc.) which can be easily identified and tracked visually using infrastructure. More generally, a ViP may have a user characteristic detectable by image data, audio data, RF data, or a combination thereof. Infrastructure device(s) can detect the user characteristic and server 870 may use the detected user characteristic to determine the position of the ViP and navigate the ViP to the target asset using navigation instructions generated by infrastructure along a selected route.

At 806, a ViP can provide a list of target assets if one has not been provided previously. For example, a ViP without a wireless device can provide the list of target assets at customer service or a self-service kiosk, while a ViP with a wireless device 825 can enter the list of target assets with a user interface. For an AGV, a list of target assets can be provided at the site or an external site (for an AGV associated with an external entity). For example, server 870 or an external server can provide a target asset list, or the AGV can provide the target asset list.

In some implementations, all or some of a target asset list can be provided prior to initiation of the navigation process at the site. For example, a user can provide a list of target asset(s) by accessing a website or a smartphone application, using wireless device 825 or a different device. The list of target asset(s) can be provided or augmented by a third party such as a family member, caregiver, or employer. In some implementations, the list of targets may be delivered to the server via a smartphone application using audio digital assistants to enable a ViP to generate the list.

At 808-a to 808-e, server 870 can access navigation environment information from (respectively) one or more wireless devices 825, an infrastructure vision system 820, an infrastructure audio system 830, an infrastructure RF system 840, an infrastructure sensor system 845, or a combination thereof (i.e., from any one, any combination, or all of the devices/systems). For example, server 870 can receive image data from one or more cameras, audio data from one or more microphones, RF data from one or more RF devices, sensor data from floor sensors, haptic data from one or more vibration sensors, one or more AGVs, etc. By fusing information from different sensor systems, the system can monitor the navigation environment in order to detect and/or predict navigation impediments and generate safe and accurate routes for a ViP or AGV based on the navigation environment information. For example, server 870 may “scan” the environment, using infrastructure cameras such as CCTV-Cams or shelf cams of vision system 820, perform audio sensing using audio information from wireless device 825 and/or audio system 830, and access available position information for other users and/or objects in the space. Although shown as a separate step in process 800, the navigation environment may be monitored in an ongoing manner as one or more ViPs navigate the site. For example, server 870 can obtain updated information indicative of the navigation environment recurrently, based on an occurrence of an event, based on a schedule, or a combination thereof. Different infrastructure devices can obtain updated navigation environment according to different timing; for example, CCTV may operate recurrently/continuously (“always on”), while shelf cameras may operate based on motion detection or other trigger (“on demand”). Note that recurrently/continuously refers to obtaining information in an ongoing manner but does not preclude batched or other transmissions that have some time periods in which information is not obtained.

At 810, server 870 may generate a first route to one or more target assets; for example, by evaluating one or more potential routes and selecting the first route based on the evaluation. For multiple target assets, the first route may be a route to fewer than all of the target assets, with additional routes to be determined after completion of the first route, or the first route may be a complete route encompassing retrieval of all target assets, which may be updated if needed due to changes in the navigation environment. The route extends from a start location to location(s) proximate one or more of the target assets; for example, to a specific aisle of the site and portion of the aisle in which a target asset is located.

In order to generate the first route, the server may evaluate different potential routes from the start location to the location(s) proximate the target asset(s), and select the first route based on detection/prediction of navigation impediments, the estimated length/estimated traversal time of potential routes, the capability of the wireless device to generate navigation instructions for a user, the need for infrastructure assistance in generating the navigation instructions for the user and/or other factors. For example, based on information indicative of the navigation environment, the server may determine that a potential route encompassing the shortest distance/smallest estimated traversal time has a substantial navigation impediment (e.g., is substantially congested, has a substantial hazard, etc.) at the time of route determination. Based on the difficulty of navigating an impeded route segment safely, the server may select a longer potential route that is more easily navigated by a ViP or AGV. However, if selection of a route without congestion increases the distance/time to navigate the route substantially, server 870 may select a shorter route with a relatively safe level of congestion. A general guideline may be to select uncongested, clear routes with estimated ViP arrival time within reasonable, predetermined limits. In some implementations, the server may use predictive techniques to predict the movement of a person or mobile object and select a route using the prediction of a time or time range during which segment(s) of potential routes may be impeded or when existing navigation impediments may clear. In order to evaluate potential routes, server 870 accesses map information indicative of parameters such as the placement, length, and effective width of navigable potential routes, as well as placement of target assets.

The computation of the route, and determining which route is “good” may be also informed by the technological capability of the ViP and the availability of systems to communicate the navigation commands/instructions to the ViP. For example, a wireless device 825 that has RF capability and is equipped with audio and haptic capabilities (integrated with the RF-capable wireless device 825 and/or provided by one or more wireless devices in communication with the RF-capable wireless device) may be able to receive navigation commands continuously/recurrently using the RF interface, along any route. With this capability, the wireless device can receive highly accurate navigation commands, responsive to the navigation environment and having fine granularity and resolution. By contrast, in an example where a ViP does not have a wireless device with RF capability, navigation commands may be delivered using audio cues and signals coming from PA speakers, which relies on the placement of infrastructure devices at the site and may provide navigation instructions with significantly coarser granularity. If the ViP carries a wireless device 825 with more limited capability, such as a store-provided smart cane, the navigation instructions may be delivered through haptic signaling techniques such as cane vibrations, which may use a narrower signaling channel bandwidth over which the commands are delivered and may be prone to ambient interference. Therefore, in some implementations the server may evaluate potential routes based on infrastructure availability, wireless device type, and/or wireless device configuration, particularly when a ViP or AGV may not be able to receive high fidelity route information.

In some aspects, server 870 may use characteristics of route segments to evaluate potential routes. The information can include map information for the route segments, information indicative of the navigation environment for the route segments, and/or information about infrastructure along the route segment that can monitor the ViP and/or navigation environment of the segment and/or provide navigation commands/instructions to the ViP. Navigation environment information may include detected or predicted navigation impediment information, while map information for the route segments may include position of the route segment at the site, a length of the route segment, space constraint information such as an effective width of the segment, which may be the smallest width encountered traversing the segment, or a reduced width that takes into account the ability of a ViP or AGV to pass another user/vehicle during traversal of the segment. Information about the infrastructure can include information indicative of the placement and capability of the infrastructure.

In an example, server 870 can evaluate navigable route segments of the space at the site, such as aisles and open areas incorporating one or more tables or displays to compare potential routes incorporating the route segments. In one example, the server may assign an estimated traversal time for segments of potential routes, where the estimate takes navigation impediments such as congestion and hazards into account, and select a safe route with a shortest estimated traversal time, where the safe route does not include route segments with significant navigation impediments. Server 870 may designate some route segments as non-navigable based on significant navigation impediments such as significant congestion or blockage, spills, broken glass, customer altercations, or other circumstances that make the segment unsafe for the ViP. If the ViP has space constraints (for example, based on use of a motorized cart or other mobility aid), segments may be designated as non-navigable based on the space constraints.

In another implementation, the server may evaluate the navigation environment based on some or all of the above parameters, and select a first route based on scoring potential routes. For example, the server can assign a score to route segments reflecting route length, congestion, hazards, aisle width/effective aisle width, or other factors affecting safety, accuracy, and/or timeliness for the segment. Scoring may also take into account the capability of the ViP, capabilities of one or more wireless devices 825, positioning and/or capability of one or more infrastructure devices, etc. Route selection may include evaluating the scores to select a route that meets safety and timeliness constraints. As with the implementation above, one or more potential segments may be designated as unnavigable based on ViP or AGV characteristics (e.g., the ViP uses a mobility cart that is incompatible with the effective width of the segment), based on the current navigation environment of the segment (e.g., a hazard such as a spill, broken glass, active customer altercation etc.), and/or based on the capability of the ViP/user equipment to receive navigation commands or instructions when the ViP is traversing the segment. In some implementations, server 870 may use predictive techniques to predict the movement of a person or mobile object and assign a score to a route segment based on predicting a time or time range during which the route segment may be impeded or when existing navigation impediment may clear.

After selection of the first route, the server generates information indicative of one or more navigation commands to traverse the first route. The navigation commands are configured for the modalities of the ViP navigation; for example, the navigation may initiate audible and/or haptic navigation instructions in a wireless device 825 such as a smartphone, haptic signals in a smart cane, or audible instructions from a PA system for users without an RF device. Similarly, navigation commands for an AGV may be configured for RF, audible, and/or visual communication with the AGV to navigate the AGV along the selected route.

A key challenge of targeted navigation of a ViP is to communicate path information to the ViP in the form of navigation instructions. After a route is selected, the route is parsed into a set of navigation commands to be delivered sequentially to the ViP as navigation instructions. In some implementations, a look-ahead window may be enabled; that is, rather than transmitting the next navigation command, server 870 can transmit a plurality of navigation commands that can provide notice of future navigation instruction(s) to the ViP.

The navigation commands can include movement directives, descriptive instructions, and primitives. Navigation commands can encode precise navigation information such as the direction of movement relative to the subject, number of steps in a given direction, path correction instructions, as well as emergency cues in case of impending collision with another person or object. Navigation commands for ViPs and/or AGVs can be based on a navigation command codebook, which include general use instructions, instructions tailored to the site, or both. Navigation instructions can be tailored to the type of assets at the site, site size, format of the area, type of site-provided assistance, etc. The navigation command codebook need not use a particular format.

At 812-a to 812-e, server 870 communicates the navigation commands to (respectively) one or more wireless devices 825, an infrastructure vision system 820, an infrastructure audio system 830, an infrastructure RF system 840, an infrastructure sensor system 845, or a combination thereof. For a RF-capable wireless device 825, server 870 may transmit the navigation commands to wireless device 825 electromagnetically, using a RF communication technology such as WiFi. This can be accomplished in different ways depending on the implementation. The received navigation commands are decoded and used to navigate an AGV or generate navigation instructions for a ViP using haptic and/or audio communication. Audio communication may use an audio device such as an on-board speaker, wired or wireless headphones, a connected hearing aid, etc. Haptic communication may use on-board vibration or one or more haptic accessories (e.g., one or more vibrating wristbands, buzzers, etc.). In some cases, visual cues tailored to the visually impaired may be used if appropriate; for example, a person with some eyesight may have a device enabled to generate large, bright, or otherwise discernable prompts as well as audio and/or haptic navigation instructions. In some examples, an RF-capable wireless device 825 can support high-fidelity navigation path information delivered quickly and reliably to the ViP.

For a ViP with a less capable wireless device 825 or without a wireless device, navigation commands may be delivered to one or more site-provided devices and/or to infrastructure devices. In some implementations, the ViP may be equipped just with a microphone (e.g. a store-provided simple microphone device). Navigation commands can be provided to infrastructure audio system 830, and navigation instructions based on the navigation commands may be delivered from the PA speakers to the receiving ViP microphone at an acoustic frequency band just above the audible range, where orthogonalization is easily achieved. Similarly, when the ViP is equipped with a smart cane with a microphone and/or a relatively low power, low bandwidth radio, the navigation commands can be delivered over either of those interfaces and parsed into navigation instructions communicated with mechanical vibrations in the cane with varying frequencies that modulate path information. In general, navigation commands can be transmitted to a wireless device 825 directly and used to generate navigation instructions, transmitted to one or more infrastructure devices to be signaled to wireless device 825 using a signaling protocol supported by wireless device 825 (e.g., short range RF signaling or acoustic signaling) for generation for navigation instructions, or transmitted to one or more infrastructure devices which generate the navigation instructions.

More generally, server 870 may transmit navigation commands to audio system 830 to generate audio navigation instructions (e.g., using the PA system). If a wireless device is configured to receive audio signaling (e.g., using soundwaves beyond the hearable range), server 870 may transmit navigation commands to audio system 830 to transmit the navigation commands to wireless device 825 or to generate navigation instructions using (for example) the PA system. If the wireless device 825 is configured to receive short range RF signals, server 870 may transmit navigation commands to RF system 840, which can in turn transmit navigation commands to wireless device 825. If the site uses a sensor system 845 such as a floor sensor system, server 870 may transmit navigation commands to sensor system 845 to generate navigation instructions for the ViP.

Server 870 may dynamically assess the navigation environment as a ViP or AGV is traversing the site, and perform operations to maintain the route if indicated. For example, server 870 may receive navigation environment information from wireless device(s) and/or infrastructure device(s) in an ongoing manner, at 808-a to 808-e. Error detection and navigation environment assessment can both use information indicative of a position of the user, other persons, objects, hazards, etc. In some implementations, positioning is performed by the Hybrid Processing and Positioning Engine (HPPE) module of server 870 in communication with ENDS functionality of server 870. Depending on the specific available technologies and the specific implementation of the HPPE, some example systems can use visual feed from cameras such as CCTV cameras, shelf cameras, and/or mobile device cameras, which may be augmented by audio, RF, sensor, and/or other information, particularly in areas not fully visible with existing cameras (referred to as visually-occluded areas).

If server 870 detects one or more conditions for evaluating the route at 814, it may determine if a route change is indicated at 816. As noted above, example conditions for evaluating the route include a change in the target asset list, a detection of user error in executing navigation instructions, or a change in the navigation environment (such as the detection or prediction of a navigation impediment such as a possible collision with a person or object, or resolution of a previous navigation impediment).

If server 870 determines a route correction or recalculation is needed, server 870 determines a route correction or selects a second route from one or more potential routes at 818; for example, using the same technique for first route selection described above. At 819-a to 819-e, server 870 communicates updated navigation commands to (respectively) one or more wireless devices 825, an infrastructure vision system 820, an infrastructure audio system 830, an infrastructure RF system 840, an infrastructure sensor system 845, or a combination thereof. Route correction refers to providing corrective navigation commands to correct an error in navigation or other deviation to resume the current route, while route recalculation refers to repeating the route selection process to select a route from one or more potential routes. In general, route correction may be preferred when a navigation error or navigable impediment in one or more of route segments of a current route are detected, while route recalculation may be preferred based on detected or predicted changes to the navigation environment in one or more of the route segments, or for a change to the target asset list.

For example, if a ViP misses an indicated turn, server 870 may generate navigation commands to correct the error and resume the current route. Route correction commands may include an indication of where they are to be inserted in the set of commands for the existing route, and if they replace any of the existing commands. For example, if the ViP missed a left turn and continued along an incorrect route segment, a route correction would instruct the ViP to retrace their steps and execute the turn correctly to resume the current route. The route correction commands could include the addition of a command for a 180 degree turn, addition of a command to take a number of steps back toward the missed turn, and replace the left turn with a right turn to complete the correction. If the deviation from the route is substantial, server 870 may determine to recalculate the route to determine if a different route is safer or more efficient than correcting the error in executing the current route.

Detection or prediction of a change in navigation environment or a change in the target asset list may trigger server 870 to determine whether a change in the current route is indicated. In some implementations, the list can be modified by a ViP interacting with a user or site-provided wireless device 825, or by visiting dedicated kiosks/checkpoints equipped with technology for the visually impaired (e.g., with microphones for audible input). In some implementations, the list may be modified automatically based on inventory changes or by changes in item placement at the site, or can be modified by a third party based on access and permission.

In some cases, a route change may not be indicated based on detecting the one or more conditions for evaluating the route, in which case server 870 continues to transmit navigation commands for the route sequentially to wireless device 825 and/or one or more infrastructure devices at 812-a to 812-e. For example, if an additional target asset can be retrieved using the current route, no route recalculation may be indicated. Additionally, if a change in navigation environment does not meet one or more conditions, no route recalculation may be indicated. For example, server 870 may compare current and/or predicted position information for an object or person with a distance threshold indicating a likely collision, and if the comparison indicates a collision is unlikely, server 870 may not recalculate the route. However, if the change in navigation environment indicates a detected or predicted navigation impediment along the current route (e.g., based on the comparison of the actual or predicted position information with the distance threshold), resolution of a detected or prediction navigation impediment along a shorter or otherwise preferred route, or a change in target asset list that requires a change to the current route, server 870 may recalculate the route at 818 to generate a second route. For example, when a remaining portion of the first route includes one or more substantially impeded or unnavigable route segments, the second route may omit each of these route segments. The process shown in FIG. 8 can be repeated as the ViP or AGV traverses the site to retrieve the assets on the target asset list (and/or perform other actions).

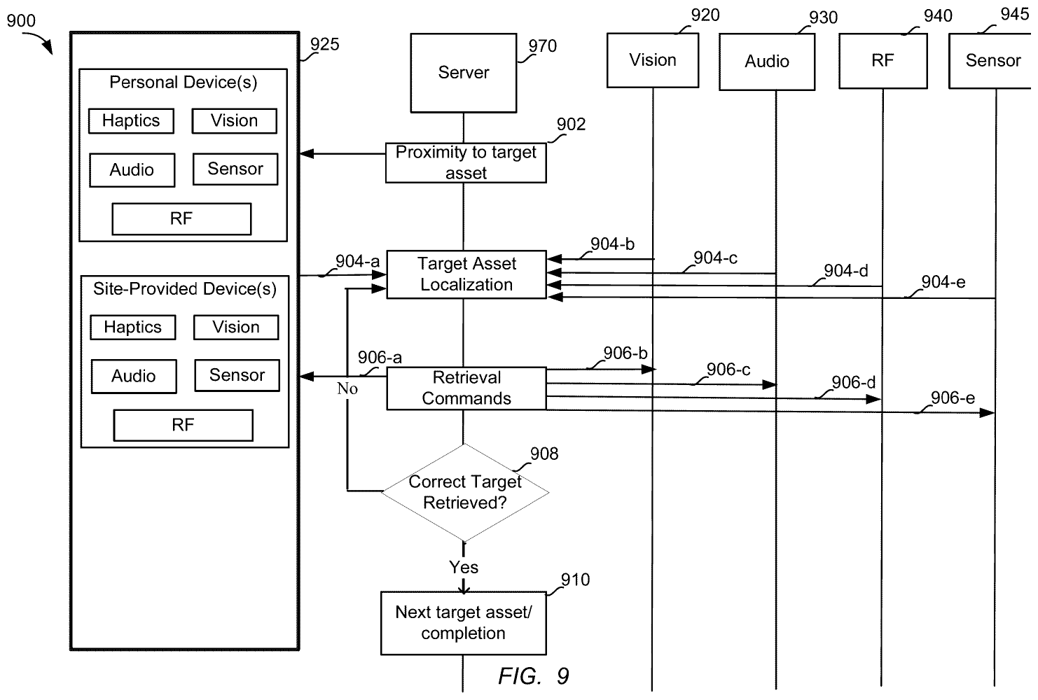

Upon detecting that the ViP or AGV is located proximate a target asset, a retrieval process may be initiated. FIG. 9 shows an example process 900 to retrieve the correct target asset from its location. At 902, server 970 may generate an indication that the ViP or AGV is proximate a target asset. For example, based on input from a wireless device 925, or from one or more infrastructure devices included in infrastructure vision system 920, infrastructure audio system 930, infrastructure RF system 940, infrastructure sensor system 945, or a combination thereof, server 970 may determine that the ViP or AGV is within a threshold distance of the target asset.

At 904-a to 904-e, server 970 may receive localization information for the target asset and the relative position of the ViP or AGV. For example, one or more positioning techniques can be used to determine the precise location of the target asset; e.g., using fusion of hybrid positioning technologies, depending on availability.

In a first example aspect, if wireless device 925 is an RF-capable wireless device, server 970 may receive localization information from infrastructure RF system 940 and/or wireless device 925. Using RF signals, a high-fidelity RF-based positioning solution may be available in a region proximate the target asset that can locate the target asset with high accuracy (e.g., within 10-20 centimeters). The high-fidelity RF-based positioning solution may incorporate an ESL-BLE infrastructure as part of infrastructure RF system 940; for example, where each asset type is associated with a separate ESL. If ESL-BLE beacons are available, server 870 may receive information indicative of the ESL beacons and their respective IDs. Server 870 can then determine localization information based on the ESL IDs (which indicates the location of the associated ESL) and beacon information that indicates the relative distance/direction from the beacons.

In another example aspect, server 970 may receive localization information from infrastructure vision system 920 and/or one or more cameras associated with wireless device 925. If the location of the target asset is not vision-occluded, infrastructure cameras such as CCTV cameras, shelf cameras, or a combination can provide image data for the desired target asset and/or relative position of the ViP to server 970. If wireless device 925 has one or more cameras, the ViP may be directed to scan nearby surroundings to capture image data of the target asset. For example, server 870 may use information provided by infrastructure systems to direct the ViP to scan a particular region near the target asset, which may protect the privacy of nearby users. The image data may be locally processed by an application on wireless device 925, and/or sent to server 970 for processing, to determine localization information.

In another example aspect, server 970 may receive localization information from infrastructure audio system 930. If audio system 930 includes a sufficiently dense deployment of speakers at the site and if wireless device 925 includes a microphone (either integrated with wireless device 925 or as a separate device), audio signals may be used to localize and/or retrieve the target asset. Localization may use audio signals in the region at the high end of the hearable frequency range or above, while retrieval commands may be provided using devices such as headphones, hearing aids, or ear buds.

In another example aspect, server 970 may receive localization information from sensor system 945. For example, if the site incorporates floor sensors, server 970 may receive information from the floor sensor system to determine a relative position of the ViP with respect to the target asset.

In some aspects, the above techniques can be combined. For example, in vision occluded regions of the site, RF, audio, or sensor systems can provide target asset localization information.

Once the target asset is localized with respect to a current position of the ViP or AGV, server 970 may generate retrieval commands, and at 906-a to 906-e, server 970 communicates retrieval commands to (respectively) one or more wireless devices 925, an infrastructure vision system 920, an infrastructure audio system 930, an infrastructure RF system 940, an infrastructure sensor system 945, or a combination thereof which are then used to generate retrieval instructions for the ViP, which may include user movement instructions, for example instructing the ViP to move in one or more directions, scan a camera, reach toward a particular shelf or shelf location, or the like. The retrieval instructions may include audio instructions, haptic instructions, and in the case of a ViP with some vision, visual instructions. Because the process or retrieving a target asset may be iterative, server 970 may receive localization information in an ongoing manner and transmit retrieval commands that direct the ViP precisely to the target asset.

In some implementations, additional supporting techniques can be used to facilitate accurate retrieval of a target asset. For example, product labels such as braille codes can be embedded on the shelves or the products themselves.

At 908, server 970 may determine whether the target asset has been retrieved, or whether a different asset has been erroneously retrieved. For example, image data from vision system 920 or user cameras can be used to determine whether the correct asset has been retrieved. In another example, sensing system 945 may include weight sensors on the shelves, and server 970 may determine whether the correct asset has been retrieved by comparing a change in weight to the weight of the target asset. If an incorrect asset has been retrieved, server 970 repeats the localization and retrieval process until the correct asset has been retrieved. In some examples, after a threshold number of incorrect retrievals, server 970 will generate and indication for customer service to assist the ViP at the current location.

At 910, if the target asset was successfully retrieved, the ViP or AGV is navigated to the next target asset along the route (or a new route is calculated if server 970 is configured to generate the route to navigate to fewer than all of the target assets and a new route is needed).

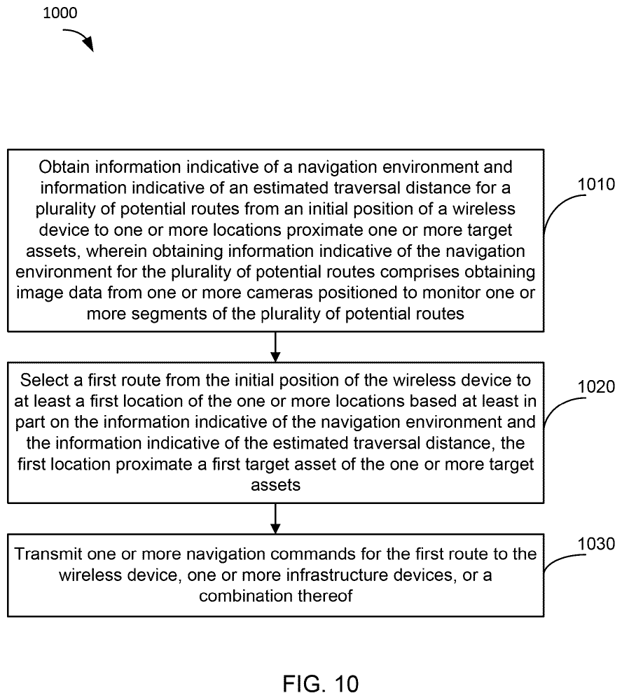

FIG. 10 illustrates an example method 1000 of communication, according to aspects of the disclosure. In an aspect, method 1000 may be performed by a network entity such as a server (e.g., any of the servers described herein).

At 1010, a network entity obtains information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes. In an aspect, operation 1010 may be performed by network interface 790, data bus 792, navigation system 798 (e.g., including HPPE Component(s) 717 and ENDS Component(s) 718), memory 796, and processor(s) 794, any or all of which may be considered means (structure) for performing this operation.

At 1020, the network entity selects a first route from the initial position of the wireless device to at least a first location of the one or more locations based at least in part on the information indicative of the navigation environment and the information indicative of the estimated traversal distance, the first location proximate a first target asset of the one or more target assets. In an aspect, operation 1020 may be performed by network interface 790, data bus 792, navigation system 798 (e.g., including HPPE Component(s) 717 and ENDS Component(s) 718), memory 796, and processor(s) 794, any or all of which may be considered means (structure) for performing this operation.

At 1030, a network entity transmits one or more navigation commands for the first route to the wireless device, one or more infrastructure devices, or a combination thereof. In an aspect, operation 1030 may be performed by network interface 790, data bus 792, navigation system 798 (e.g., including HPPE Component(s) 717 and ENDS Component(s) 718), memory 796, and processor(s) 794, any or all of which may be considered means (structure) for performing this operation.

As will be appreciated, a technical advantage of method 1000 is providing safe, accurate, and timely navigation information. The navigation information may be used by (for example) a ViP, AGV, or other entity traversing a site. Method 1000 considers information indicative of a navigation environment for a plurality of potential routes, as well as information indicative of an estimated traversal distance (which may be in the form of an estimated traversal time in some cases) to select a first route.

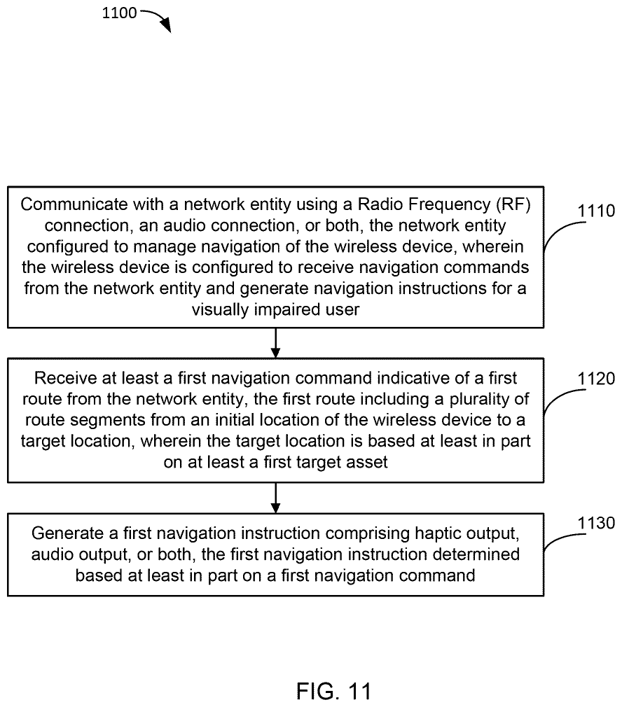

FIG. 11 illustrates an example method 1100 of communication, according to aspects of the disclosure. In an aspect, method 1100 may be performed by a wireless device (e.g., any of the wireless devices/user equipments described herein).

At 1110, the wireless device communicates with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user. In some implementations, operation 1110 can be performed, for example, using WWAN transceiver(s) 310, short range transceiver(s) 320, processor(s) 332, memory 340, and/or positioning component(s) 342 of UE 302, which may be considered means (structure) for performing operation 1110.

At 1120, the wireless device receives at least a first navigation command indicative of a first route from the network entity, the first route including a plurality of route segments from an initial location of the wireless device to a target location, wherein the target location is based at least in part on at least a first target asset. In some implementations, operation 1120 can be performed, for example, using WWAN transceiver(s) 310, short range transceiver(s) 320, processor(s) 332, memory 340, and/or positioning component(s) 342 of UE 302, which may be considered means (structure) for performing operation 1120.

At 1130, the wireless device generates a first navigation instruction comprising haptic output, audio output, or both, the first navigation instruction determined based at least in part on a first navigation command. In some implementations, operation 1130 can be performed, for example, using WWAN transceiver(s) 310, short range transceiver(s) 320, processor(s) 332, memory 340, and/or positioning component(s) 342 of UE 302, which may be considered means (structure) for performing operation 1130.

As will be appreciated, a technical advantage of the method 1100 is the ability of a wireless device to interact with a network entity such as a server to receive information about a safe, accurate, and timely route for a ViP. The wireless device generates haptic output, audio output or both to instruct the ViP to traverse the site according to the route information received from the server. As a result, the ViP may be able to perform complicated navigation, as well as to retrieve target assets even when they are positioned among other similar assets.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A network entity, comprising: one or more memories; one or more transceivers; and one or more processors communicatively coupled to the one or more memories and the one or more transceivers, the one or more processors, either alone or in combination, configured to: obtain information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes; select a first route from the initial position of the wireless device to at least a first location of the one or more locations based at least in part on the information indicative of the navigation environment and the information indicative of the estimated traversal distance, the first location proximate a first target asset of the one or more target assets; and transmit, via the one or more transceivers, one or more navigation commands for the first route to the wireless device, one or more infrastructure devices, or a combination thereof.

Clause 2. The network entity of clause 1, wherein the one or more processors, either alone or in combination, are further configured to process the image data to detect or predict one or more navigation impediments.

Clause 3. The network entity of any of clauses 1 to 2, wherein, to use the information indicative of the navigation environment to select the first route, the one or more processors, either alone or in combination, are further configured to detect or predict a navigation impediment in an impeded segment of a non-selected route of the plurality of potential routes, wherein the non-selected route is shorter than the first route.

Clause 4. The network entity of any of clauses 1 to 3, wherein, to obtain the image data from the one or more cameras positioned to monitor the one or more segments of the plurality of potential routes, the one or more processors, either alone or in combination, are configured to receive image data obtained by one or more infrastructure devices, one or more mobile devices, or both, and further configured to: detect or predict one or more navigation impediments based at least in part on the image data; and obtain updated information indicative of the navigation environment recurrently, based at least in part on an occurrence of an event, based at least in part on a schedule, or a combination thereof.

Clause 5. The network entity of any of clauses 1 to 4, wherein, to obtain the information indicative of the navigation environment for the plurality of potential routes, the one or more processors, either alone or in combination, are configured to receive audio data obtained by one or more audio infrastructure devices, one or more mobile devices, or both, and further configured to: detect or predict one or more navigation impediments based at least in part on the audio data; and obtain updated information indicative of the navigation environment recurrently, based on an occurrence of an event, based at least in part on a schedule, or a combination thereof.

Clause 6. The network entity of any of clauses 1 to 5, wherein the wireless device is associated with a visually impaired user, and wherein the one or more processors are further configured to: obtain information indicative of one or more capabilities of the wireless device, a battery status of the wireless device, a medium access control (MAC) address of the wireless device, a radiofrequency (RF) status of the wireless device, or a combination thereof; and establish a connection with the wireless device.

Clause 7. The network entity of any of clauses 1 to 5, wherein the wireless device is included in an automated guided vehicle (AGV).

Clause 8. The network entity of any of clauses 1 to 6, wherein the wireless device is associated with a visually impaired user and comprises a device integrated with a mobility cart, a device integrated with a mobility aid, a device with one or more speakers, a device with one or more microphones, a device with one or more cameras, a device with vibration capability, or a combination thereof.

Clause 9. The network entity of any of clauses 1 to 6, and 8, wherein a detectable user characteristic is associated with a user identifier of the wireless device, wherein the user characteristic is detectable by image data, audio data, RF data, or a combination thereof, and wherein the one or more processors, either alone or in combination, are further configured to: detect the user characteristic using image data, audio data, RF data or the combination thereof received from at least one infrastructure device; and determine a position of the wireless device based at least in part on detecting the user characteristic.

Clause 10. The network entity of any of clauses 1 to 9, wherein the one or more processors, either alone or in combination, are further configured to: determine a set of navigation commands for the first route, the set of navigation commands including the one or more navigation commands for the first route; and wherein, to transmit the one or more navigation commands for the first route to the wireless device, one or more infrastructure devices, or the combination thereof, the one or more processors, either alone or in combination, are configured to transmit the one or more navigation commands sequentially.

Clause 11. The network entity of clause 10, wherein, to determine the set of navigation commands, the one or more processors, either alone or in combination, are configured to select the set of navigation commands based at least in part on one or more wireless device capabilities, and further configured to transmit the one or more navigation commands to the wireless device using a signaling protocol supported by the wireless device.

Clause 12. The network entity of clause 11, wherein the wireless device includes one or more microphones, and wherein the one or more processors, either alone or in combination, are configured to transmit the one or more navigation commands using a signaling protocol supported by the wireless device by instructing at least one infrastructure speaker to transmit the navigation commands using a signaling protocol using sound waves, and are further configured to: establish a connection with the wireless device using sound wave signaling, RF signaling, or a combination thereof.

Clause 13. The network entity of any of clauses 1 to 12, wherein the one or more processors, either alone or in combination, are further configured to: obtain information indicative of a detected or predicted navigation impediment for at least one impeded route segment included in a remaining portion of the first route, subsequent to transmitting at least one of the one or more navigation commands for the first route to the wireless device, one or more infrastructure devices, or the combination thereof and at a subsequent position of the wireless device; obtain information indicative of a navigation environment and information indicative of an estimated traversal distance for a plurality of potential routes from the subsequent position of the wireless device to the one or more locations proximate the one or more target assets; and select a second route to the first location proximate the first target asset based at least in part on the information indicative of the navigation environment and the information indicative of the estimated traversal distance for the plurality of potential routes from the subsequent position of the wireless device to the first location proximate the first target asset, the second route not including the at least one impeded route segment.

Clause 14. The network entity of any of clauses 1 to 13, wherein the one or more processors, either alone or in combination, are further configured to: determine that the wireless device has deviated from the first route, subsequent to transmitting the one or more navigation commands for the first route to the wireless device, one or more infrastructure devices, or the combination thereof; and transmit one or more corrective navigation commands to the wireless device, one or more infrastructure devices, or a combination thereof.

Clause 15. The network entity of any of clauses 1 to 14, wherein the one or more processors, either alone or in combination, are further configured to: obtain an updated target asset list subsequent to transmitting the one or more navigation commands for the first route to the wireless device, one or more infrastructure devices, or the combination thereof; obtain updated information indicative of the navigation environment and information indicative of an estimated traversal distance for one or more potential routes based at least in part on the updated target asset list; and use the updated target asset list, the updated information indicative of the navigation environment for the one or more potential routes, and the information indicative of the estimated traversal distance for the one or more potential routes to select a second route, wherein the second route includes at least one different route segment than a remaining portion of the first route.

Clause 16. The network entity of any of clauses 1 to 15, wherein the one or more processors, either alone or in combination, are further configured to: detect a position of the wireless device proximate the first target asset; and transmit, via the one or more transceivers, one or more retrieval commands to the wireless device, one or more infrastructure devices, or a combination thereof.

Clause 17. The network entity of clause 16, wherein the wireless device is associated with a visually impaired user, and wherein the one or more retrieval commands comprise commands to generate user movement instructions at the wireless device, one or more infrastructure devices, or a combination thereof.

Clause 18. The network entity of clause 17, wherein the one or more processors, either alone or in combination, are further configured to: receive, via the one or more transceivers, RF data, image data, audio data, or a combination thereof indicating user position information in response to the user movement instructions; and transmit, via the one or more transceivers, one or more additional retrieval commands to the wireless device, one or more infrastructure devices, or the combination thereof based at least in part on the user position information.

Clause 19. The network entity of any of clauses 16 to 18, wherein the one or more processors, either alone or in combination, are further configured to: determine a successful retrieval of the first target asset or an erroneous retrieval of a different asset; and transmit, via the one or more transceivers, an indication of the successful retrieval or the erroneous retrieval to the wireless device, one or more infrastructure devices, or a combination thereof.

Clause 20. The network entity of any of clauses 1 to 6 and 8 to 19, wherein the one or more processors, either alone or in combination, are further configured to: associate a user identifier to a visually impaired person without a device configured to communicate with the network entity; associate the user identifier with a detectable user characteristic, the user characteristic detectable by image data, audio data, RF data, haptic data, sensor data, or a combination thereof; detect the user characteristic using image data, audio data, RF data, haptic data, sensor data, or a combination thereof received from at least one infrastructure device; and determine a position of the visually impaired person based at least in part on detecting the user characteristic.

Clause 21. A wireless device, comprising: one or more memories; one or more transceivers; and one or more processors communicatively coupled to the one or more memories and the one or more transceivers, the one or more processors, either alone or in combination, configured to: communicate, via the one or more transceivers, with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; receive, via the one or more transceivers, at least a first navigation command indicative of a first route from the network entity, the first route including a plurality of route segments from an initial location of the wireless device to a target location, wherein the target location is based at least in part on at least a first target asset; and generate a first navigation instruction comprising haptic output, audio output, or both, the first navigation instruction determined based at least in part on a first navigation command.

Clause 22. The wireless device of clause 21, wherein the one or more processors, either alone or in combination, are further configured to: subsequently generate a second navigation instruction comprising haptic output, audio output, or both, the second navigation instruction based at least in part on a second navigation command indicative of the first route; receive one or more navigation commands indicative of an updated route to the target location during navigation of a route segment based at least in part on the second navigation instruction; and generate one or more corrective navigation instructions comprising haptic output, audio output or both, the one or more corrective navigation instructions based at least in part on the one or more navigation commands indicative of the updated route.

Clause 23. The wireless device of clause 22, wherein the one or more corrective navigation instructions comprise one or more instructions to correct an error in executing the second navigation instruction.

Clause 24. The wireless device of any of clauses 22 to 23, wherein the one or more corrective navigation instructions comprise one or more instructions for a second different route from a current location to the target location, the second different route differing in at least one route segment from a remaining portion of the first route.

Clause 25. The wireless device of any of clauses 21 to 24, wherein the one or more processors, either alone or in combination, are further configured to: transmit, via the one or more transceivers, detected RF data, image data, audio data, or a combination thereof to the network entity directly or via one or more infrastructure devices or both, the RF data image data, audio data, or both detected during navigation to the target location.

Clause 26. The wireless device of any of clauses 21 to 25, wherein the wireless device comprises a cellular phone, a cane, a mobility cart, a mobility device, a camera, a speaker, a microphone, a haptic device, a visual assistance device, or a combination thereof.

Clause 27. The wireless device of any of clauses 21 to 26, wherein the one or more processors, either alone or in combination, are further configured to: generate an indication that the wireless device is positioned proximate the first target asset; and generate one or more retrieval instructions comprising haptic output, audio output, or both.

Clause 28. The wireless device of clause 27, wherein the one or more processors, either alone or in combination, are further configured to: detect a successful retrieval of the first target asset or an erroneous retrieval of an asset different than the first target asset; in response to detecting the successful retrieval of the first target asset, generate one or more navigation instructions to a second target location; or in response to detecting erroneous retrieval of an asset different than the first target asset, generate an indication of the erroneous retrieval, generating updated retrieval instructions, or a combination thereof.

Clause 29. A method of communication at a network entity, comprising: obtaining information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes; selecting a first route from the initial position of the wireless device to at least a first location of the one or more locations based at least in part on the information indicative of the navigation environment and the information indicative of the estimated traversal distance, the first location proximate a first target asset of the one or more target assets; and transmitting one or more navigation commands for the first route to the wireless device, one or more infrastructure devices, or a combination thereof.

Clause 30. The method of clause 29, further comprising: processing the image data to detect or predict one or more navigation impediments.

Clause 31. The method of any of clauses 29 to 30, wherein selecting the first route from the initial position of the wireless device to at least the first location of the one or more locations comprises detecting or predicting a navigation impediment in an impeded segment of a non-selected route of the plurality of potential routes, wherein the non-selected route is shorter than the first route.

Clause 32. The method of any of clauses 29 to 31, wherein obtaining the image data from the one or more cameras positioned to monitor the one or more segments of the plurality of potential routes comprises receiving image data obtained by one or more infrastructure devices, one or more mobile devices, or both, and further comprises: detecting or predicting one or more navigation impediments based at least in part on the image data; and obtaining updated information indicative of the navigation environment recurrently, based at least in part on an occurrence of an event, based at least in part on a schedule, or a combination thereof.

Clause 33. The method of any of clauses 29 to 32, wherein, obtaining the information indicative of the navigation environment for the plurality of potential routes comprises receiving audio data obtained by one or more audio infrastructure devices, one or more mobile devices, or both, and further comprises: detecting or predicting one or more navigation impediments based at least in part on the audio data; and obtaining updated information indicative of the navigation environment recurrently, based on an occurrence of an event, based at least in part on a schedule, or a combination thereof.

Clause 34. The method of any of clauses 29 to 33, wherein the wireless device is associated with a visually impaired user, and further comprising: obtaining information indicative of one or more capabilities of the wireless device, a battery status of the wireless device, a medium access control (MAC) address of the wireless device, a radiofrequency (RF) status of the wireless device, or a combination thereof; and establishing a connection with the wireless device.

Clause 35. The method of any of clauses 29 to 33, wherein the wireless device is included in an automated guided vehicle (AGV).

Clause 36. The method of any of clauses 29 to 34, wherein the wireless device is associated with a visually impaired user and comprises a device integrated with a mobility cart, a device integrated with a mobility aid, a device with one or more speakers, a device with one or more microphones, a device with one or more cameras, a device with vibration capability, or a combination thereof.

Clause 37. The method of any of clauses 29 to 34 and 36, wherein a detectable user characteristic is associated with a user identifier of the wireless device, wherein the user characteristic is detectable by image data, audio data, RF data, or a combination thereof, and further comprising: detecting the user characteristic using image data, audio data, RF data or the combination thereof received from at least one infrastructure device; and determining a position of the wireless device based at least in part on detecting the user characteristic.

Clause 38. The method of any of clauses 29 to 37, further comprising: determining a set of navigation commands for the first route, the set of navigation commands including the one or more navigation commands for the first route; and wherein transmitting the one or more navigation commands for the first route to the wireless device comprises transmitting the one or more navigation commands sequentially.

Clause 39. The method of clause 38, wherein determining the set of navigation commands comprises selecting the set of navigation commands based at least in part on one or more wireless device capabilities, and further comprising: transmitting the one or more navigation commands to the wireless device using a signaling protocol supported by the wireless device.

Clause 40. The method of clause 39, wherein the wireless device includes one or more microphones, and wherein transmitting the one or more navigation commands using a signaling protocol supported by the wireless device comprises instructing at least one infrastructure speaker to transmit the navigation commands using a signaling protocol using sound waves, and further comprising: establishing a connection with the wireless device using sound wave signaling, RF signaling, or a combination thereof.

Clause 41. The method of any of clauses 29 to 40, further comprising: obtaining information indicative of a detected or predicted navigation impediment for at least one impeded route segment included in a remaining portion of the first route, subsequent to transmitting at least one of the one or more navigation commands for the first route to the wireless device, one or more infrastructure devices, or the combination thereof and at a subsequent position of the wireless device; obtaining information indicative of a navigation environment and information indicative of an estimated traversal distance for a plurality of potential routes from the subsequent position of the wireless device to the one or more locations proximate the one or more target assets; and selecting a second route to the first location proximate the first target asset based at least in part on the information indicative of the navigation environment and the information indicative of the estimated traversal distance for the plurality of potential routes from the subsequent position of the wireless device to the first location proximate the first target asset, the second route not including the at least one impeded route segment.

Clause 42. The method of any of clauses 29 to 41, further comprising: determining that the wireless device has deviated from the first route, subsequent to transmitting the one or more navigation commands for the first route to the wireless device, one or more infrastructure devices, or the combination thereof; and transmitting one or more corrective navigation commands to the wireless device, one or more infrastructure devices, or a combination thereof.

Clause 43. The method of any of clauses 29 to 42, further comprising: obtaining an updated target asset list subsequent to transmitting the one or more navigation commands for the first route to the wireless device, one or more infrastructure devices, or the combination thereof; obtaining updated information indicative of the navigation environment and information indicative of an estimated traversal distance for one or more potential routes based at least in part on the updated target asset list; and using the updated target asset list, the updated information indicative of the navigation environment for the one or more potential routes, and the information indicative of the estimated traversal distance for the one or more potential routes to select a second route, wherein the second route includes at least one different route segment than a remaining portion of the first route.

Clause 44. The method of any of clauses 29 to 43, further comprising: detecting a position of the wireless device proximate the first target asset; and transmitting one or more retrieval commands to the wireless device, one or more infrastructure devices, or a combination thereof.

Clause 45. The method of clause 44, wherein the wireless device is associated with a visually impaired user, and wherein the one or more retrieval commands comprise commands to generate user movement instructions at the wireless device, one or more infrastructure devices, or a combination thereof.

Clause 46. The method of clause 45, further comprising: receiving RF data, image data, audio data, or a combination thereof indicating user position information in response to the user movement instructions; and transmitting one or more additional retrieval commands to the wireless device, one or more infrastructure devices, or the combination thereof based at least in part on the user position information.

Clause 47. The method of any of clauses 44 to 46, further comprising: determining a successful retrieval of the first target asset or an erroneous retrieval of a different asset; and transmitting an indication of the successful retrieval or the erroneous retrieval to the wireless device, one or more infrastructure devices, or a combination thereof.

Clause 48. The method of any of clauses 29 to 34 and 36 to 47, further comprising: associating a user identifier to a visually impaired person without a device configured to communicate with the network entity; associating the user identifier with a detectable user characteristic, the user characteristic detectable by image data, audio data, RF data, haptic data, sensor data, or a combination thereof; detecting the user characteristic using image data, audio data, RF data, haptic data, sensor data, or a combination thereof received from at least one infrastructure device; and determining a position of the visually impaired person based at least in part on detecting the user characteristic.

Clause 49. A method of communication at a wireless device, comprising: communicating with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; receiving at least a first navigation command indicative of a first route from the network entity, the first route including a plurality of route segments from an initial location of the wireless device to a target location, wherein the target location is based at least in part on at least a first target asset; and generating a first navigation instruction comprising haptic output, audio output, or both, the first navigation instruction determined based at least in part on a first navigation command.

Clause 50. The method of clause 49, further comprising: subsequently generating a second navigation instruction comprising haptic output, audio output, or both, the second navigation instruction based at least in part on a second navigation command indicative of the first route; receiving one or more navigation commands indicative of an updated route to the target location during navigation of a route segment based at least in part on the second navigation instruction; and generating one or more corrective navigation instructions comprising haptic output, audio output or both, the one or more corrective navigation instructions based at least in part on the one or more navigation commands indicative of the updated route.

Clause 51. The method of clause 50, wherein the one or more corrective navigation instructions comprise one or more instructions to correct an error in executing the second navigation instruction.

Clause 52. The method of any of clauses 50 to 51, wherein the one or more corrective navigation instructions comprise one or more instructions for a second different route from a current location to the target location, the second different route differing in at least one route segment from a remaining portion of the first route.

Clause 53. The method of any of clauses 49 to 52, further comprising: transmitting detected RF data, image data, audio data, or a combination thereof to the network entity directly or via one or more infrastructure devices or both, the RF data image data, audio data, or both detected during navigation to the target location.

Clause 54. The method of any of clauses 49 to 53, wherein the wireless device comprises a cellular phone, a cane, a mobility cart, a mobility device, a camera, a speaker, a microphone, a haptic device, a visual assistance device, or a combination thereof.

Clause 55. The method of any of clauses 49 to 54, further comprising: generating an indication that the wireless device is positioned proximate the first target asset; and generating one or more retrieval instructions comprising haptic output, audio output, or both.

Clause 56. The method of clause 55, further comprising: detecting a successful retrieval of the first target asset or an erroneous retrieval of an asset different than the first target asset; in response to detecting the successful retrieval of the first target asset, generating one or more navigation instructions to a second target location; or in response to detecting erroneous retrieval of an asset different than the first target asset, generating an indication of the erroneous retrieval, generating updated retrieval instructions, or a combination thereof.

Clause 57. A network entity, comprising: means for obtaining information indicative of a navigation environment and information indicative of an estimated traversal distance for a plurality of potential routes from an initial position of a wireless device to one or more locations proximate one or more target assets, wherein the means for obtaining information indicative of the navigation environment for the plurality of potential routes comprises means for obtaining image data from one or more cameras positioned to monitor one or more segments of the plurality of potential routes; means for selecting a first route from the initial position of the wireless device to at least a first location of the one or more locations based at least in part on the information indicative of the navigation environment and the information indicative of the estimated traversal distance, the first location proximate a first target asset of the one or more target assets; and means for transmitting one or more navigation commands for the first route to the wireless device, one or more infrastructure devices, or a combination thereof.

Clause 58. The network entity of clause 57, further comprising: means for processing the image data to detect or predict one or more navigation impediments.

Clause 59. The network entity of any of clauses 57 to 58, wherein selecting the first route from the initial position of the wireless device to at least the first location of the one or more locations comprises detecting or predicting a navigation impediment in an impeded segment of a non-selected route of the plurality of potential routes, wherein the non-selected route is shorter than the first route.

Clause 60. The network entity of any of clauses 57 to 59, wherein the means for obtaining the image data from the one or more cameras positioned to monitor the one or more segments of the plurality of potential routes comprises means for receiving image data obtained by one or more infrastructure devices, one or more mobile devices, or both, and further comprises: means for detecting or predicting one or more navigation impediments based at least in part on the image data; and means for obtaining updated information indicative of the navigation environment recurrently, based at least in part on an occurrence of an event, based at least in part on a schedule, or a combination thereof.

Clause 61. The network entity of any of clauses 57 to 60, wherein the means for obtaining the information indicative of the navigation environment for the plurality of potential routes comprises means for receiving audio data obtained by one or more audio infrastructure devices, one or more mobile devices, or both, and further comprises: means for detecting or predicting one or more navigation impediments based at least in part on the audio data; and means for obtaining updated information indicative of the navigation environment recurrently, based on an occurrence of an event, based at least in part on a schedule, or a combination thereof.

Clause 62. The network entity of any of clauses 57 to 61, wherein the wireless device is associated with a visually impaired user, and further comprising: means for obtaining information indicative of one or more capabilities of the wireless device, a battery status of the wireless device, a medium access control (MAC) address of the wireless device, a radiofrequency (RF) status of the wireless device, or a combination thereof; and means for establishing a connection with the wireless device.

Clause 63. The network entity of any of clauses 57 to 61, wherein the wireless device is included in an automated guided vehicle (AGV).

Clause 64. The network entity of any of clauses 57 to 62, wherein the wireless device is associated with a visually impaired user and comprises a device integrated with a mobility cart, a device integrated with a mobility aid, a device with one or more speakers, a device with one or more microphones, a device with one or more cameras, a device with vibration capability, or a combination thereof.

Clause 65. The network entity of any of clauses 57 to 62 and 64, wherein a detectable user characteristic is associated with a user identifier of the wireless device, wherein the user characteristic is detectable by image data, audio data, RF data, or a combination thereof, and further comprising: means for detecting the user characteristic using image data, audio data, RF data or the combination thereof received from at least one infrastructure device; and means for determining a position of the wireless device based at least in part on detecting the user characteristic.

Clause 66. The network entity of any of clauses 57 to 65, further comprising: means for determining a set of navigation commands for the first route, the set of navigation commands including the one or more navigation commands for the first route; and wherein the means for transmitting the one or more navigation commands for the first route to the wireless device comprises means for transmitting the one or more navigation commands sequentially.

Clause 67. The network entity of clause 66, wherein the means for determining the set of navigation commands comprises means for selecting the set of navigation commands based at least in part on one or more wireless device capabilities, and further comprising: means for transmitting the one or more navigation commands to the wireless device using a signaling protocol supported by the wireless device.

Clause 68. The network entity of clause 67, wherein the wireless device includes one or more microphones, and wherein the means for transmitting the one or more navigation commands using a signaling protocol supported by the wireless device comprises means for instructing at least one infrastructure speaker to transmit the navigation commands using a signaling protocol using sound waves, and further comprising: means for establishing a connection with the wireless device using sound wave signaling, RF signaling, or a combination thereof.

Clause 69. The network entity of any of clauses 57 to 68, further comprising: means for obtaining information indicative of a detected or predicted navigation impediment for at least one impeded route segment included in a remaining portion of the first route, subsequent to transmitting at least one of the one or more navigation commands for the first route to the wireless device, one or more infrastructure devices, or the combination thereof and at a subsequent position of the wireless device; means for obtaining information indicative of a navigation environment and information indicative of an estimated traversal distance for a plurality of potential routes from the subsequent position of the wireless device to the one or more locations proximate the one or more target assets; and means for selecting a second route to the first location proximate the first target asset based at least in part on the information indicative of the navigation environment and the information indicative of the estimated traversal distance for the plurality of potential routes from the subsequent position of the wireless device to the first location proximate the first target asset, the second route not including the at least one impeded route segment.

Clause 70. The network entity of any of clauses 57 to 69, further comprising: means for determining that the wireless device has deviated from the first route, subsequent to transmitting the one or more navigation commands for the first route to the wireless device, one or more infrastructure devices, or the combination thereof; and means for transmitting one or more corrective navigation commands to the wireless device, one or more infrastructure devices, or a combination thereof.

Clause 71. The network entity of any of clauses 57 to 70, further comprising: means for obtaining an updated target asset list subsequent to transmitting the one or more navigation commands for the first route to the wireless device, one or more infrastructure devices, or the combination thereof; means for obtaining updated information indicative of the navigation environment and information indicative of an estimated traversal distance for one or more potential routes based at least in part on the updated target asset list; and means for using the updated target asset list, the updated information indicative of the navigation environment for the one or more potential routes, and the information indicative of the estimated traversal distance for the one or more potential routes to select a second route, wherein the second route includes at least one different route segment than a remaining portion of the first route.

Clause 72. The network entity of any of clauses 57 to 71, further comprising: means for detecting a position of the wireless device proximate the first target asset; and means for transmitting one or more retrieval commands to the wireless device, one or more infrastructure devices, or a combination thereof.

Clause 73. The network entity of clause 72, wherein the wireless device is associated with a visually impaired user, and wherein the one or more retrieval commands comprise commands to generate user movement instructions at the wireless device, one or more infrastructure devices, or a combination thereof.

Clause 74. The network entity of clause 73, further comprising: means for receiving RF data, image data, audio data, or a combination thereof indicating user position information in response to the user movement instructions; and means for transmitting one or more additional retrieval commands to the wireless device, one or more infrastructure devices, or the combination thereof based at least in part on the user position information.

Clause 75. The network entity of any of clauses 72 to 74, further comprising: means for determining a successful retrieval of the first target asset or an erroneous retrieval of a different asset; and means for transmitting an indication of the successful retrieval or the erroneous retrieval to the wireless device, one or more infrastructure devices, or a combination thereof.

Clause 76. The network entity of any of clauses 57 to 62 and 64 to 75, further comprising: means for associating a user identifier to a visually impaired person without a device configured to communicate with the network entity; means for associating the user identifier with a detectable user characteristic, the user characteristic detectable by image data, audio data, RF data, haptic data, sensor data, or a combination thereof; means for detecting the user characteristic using image data, audio data, RF data, haptic data, sensor data, or a combination thereof received from at least one infrastructure device; and means for determining a position of the visually impaired person based at least in part on detecting the user characteristic.

Clause 77. A wireless device, comprising: means for communicating with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; means for receiving at least a first navigation command indicative of a first route from the network entity, the first route including a plurality of route segments from an initial location of the wireless device to a target location, wherein the target location is based at least in part on at least a first target asset; and means for generating a first navigation instruction comprising haptic output, audio output, or both, the first navigation instruction determined based at least in part on a first navigation command.

Clause 78. The wireless device of clause 77, further comprising: means for subsequently generating a second navigation instruction comprising haptic output, audio output, or both, the second navigation instruction based at least in part on a second navigation command indicative of the first route; means for receiving one or more navigation commands indicative of an updated route to the target location during navigation of a route segment based at least in part on the second navigation instruction; and means for generating one or more corrective navigation instructions comprising haptic output, audio output or both, the one or more corrective navigation instructions based at least in part on the one or more navigation commands indicative of the updated route.

Clause 79. The wireless device of clause 78, wherein the one or more corrective navigation instructions comprise one or more instructions to correct an error in executing the second navigation instruction.

Clause 80. The wireless device of any of clauses 78 to 79, wherein the one or more corrective navigation instructions comprise one or more instructions for a second different route from a current location to the target location, the second different route differing in at least one route segment from a remaining portion of the first route.

Clause 81. The wireless device of any of clauses 77 to 80, further comprising: means for transmitting detected RF data, image data, audio data, or a combination thereof to the network entity directly or via one or more infrastructure devices or both, the RF data image data, audio data, or both detected during navigation to the target location.

Clause 82. The wireless device of any of clauses 77 to 81, wherein the wireless device comprises a cellular phone, a cane, a mobility cart, a mobility device, a camera, a speaker, a microphone, a haptic device, a visual assistance device, or a combination thereof.

Clause 83. The wireless device of any of clauses 77 to 82, further comprising: means for generating an indication that the wireless device is positioned proximate the first target asset; and means for generating one or more retrieval instructions comprising haptic output, audio output, or both.

Clause 84. The wireless device of clause 83, further comprising: means for detecting a successful retrieval of the first target asset or an erroneous retrieval of an asset different than the first target asset; means for generating one or more navigation instructions to a second target location; or means for generating an indication of the erroneous retrieval, generating updated retrieval instructions, or a combination thereof.

Clause 85. A non-transitory computer-readable medium storing computer-executable instructions that, when executed by a network entity, cause the network entity to: obtain information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes; select a first route from the initial position of the wireless device to at least a first location of the one or more locations based at least in part on the information indicative of the navigation environment and the information indicative of the estimated traversal distance, the first location proximate a first target asset of the one or more target assets; and transmit one or more navigation commands for the first route to the wireless device, one or more infrastructure devices, or a combination thereof.

Clause 86. The non-transitory computer-readable medium of clause 85, further comprising computer-executable instructions that, when executed by the network entity, cause the network entity to: process the image data to detect or predict one or more navigation impediments.

Clause 87. The non-transitory computer-readable medium of any of clauses 85 to 86, wherein the instructions to select the first route from the initial position of the wireless device to at least the first location of the one or more locations comprise instructions to detect or predict a navigation impediment in an impeded segment of a non-selected route of the plurality of potential routes, wherein the non-selected route is shorter than the first route.

Clause 88. The non-transitory computer-readable medium of any of clauses 85 to 87, wherein the computer-executable instructions that, when executed by the network entity, cause the network entity to obtain the image data from the one or more cameras positioned to monitor the one or more segments of the plurality of potential routes comprise computer-executable instructions that, when executed by the network entity, cause the network entity to receive image data obtained by one or more infrastructure devices, one or more mobile devices, or both, and further comprising computer-executable instructions that, when executed by the network entity, cause the network entity to: detect or predict one or more navigation impediments based at least in part on the image data; and obtain updated information indicative of the navigation environment recurrently, based at least in part on an occurrence of an event, based at least in part on a schedule, or a combination thereof.

Clause 89. The non-transitory computer-readable medium of any of clauses 85 to 88, wherein the instructions to obtain the information indicative of the navigation environment for the plurality of potential routes comprise instructions to receive audio data obtained by one or more audio infrastructure devices, one or more mobile devices, or both, and further comprising computer-executable instructions that, when executed by the network entity, cause the network entity to: detect or predict one or more navigation impediments based at least in part on the audio data; and obtain updated information indicative of the navigation environment recurrently, based on an occurrence of an event, based at least in part on a schedule, or a combination thereof.

Clause 90. The non-transitory computer-readable medium of any of clauses 85 to 89, wherein the wireless device is associated with a visually impaired user, and further comprising computer-executable instructions that, when executed by the network entity, cause the network entity to: obtain information indicative of one or more capabilities of the wireless device, a battery status of the wireless device, a medium access control (MAC) address of the wireless device, a radiofrequency (RF) status of the wireless device, or a combination thereof; and establish a connection with the wireless device.

Clause 91. The non-transitory computer-readable medium of any of clauses 85 to 89, wherein the wireless device is included in an automated guided vehicle (AGV).

Clause 92. The non-transitory computer-readable medium of any of clauses 85 to 90, wherein the wireless device is associated with a visually impaired user and comprises a device integrated with a mobility cart, a device integrated with a mobility aid, a device with one or more speakers, a device with one or more microphones, a device with one or more cameras, a device with vibration capability, or a combination thereof.

Clause 93. The non-transitory computer-readable medium of any of clauses 85 to 90 and 92, wherein a detectable user characteristic is associated with a user identifier of the wireless device, wherein the user characteristic is detectable by image data, audio data, RF data, or a combination thereof, and further comprising computer-executable instructions that, when executed by the network entity, cause the network entity to: detect the user characteristic using image data, audio data, RF data or the combination thereof received from at least one infrastructure device; and determine a position of the wireless device based at least in part on detecting the user characteristic.

Clause 94. The non-transitory computer-readable medium of any of clauses 85 to 93, further comprising computer-executable instructions that, when executed by the network entity, cause the network entity to: determine a set of navigation commands for the first route, the set of navigation commands including the one or more navigation commands for the first route; and transmit the one or more navigation commands sequentially.

Clause 95. The non-transitory computer-readable medium of clause 94, wherein the computer-executable instructions that, when executed by the network entity, cause the network entity to determine the set of navigation commands comprise computer-executable instructions to select the set of navigation commands based at least in part on one or more wireless device capabilities, and further comprising computer-executable instructions that, when executed by the network entity, cause the network entity to: transmit the one or more navigation commands to the wireless device using a signaling protocol supported by the wireless device.

Clause 96. The non-transitory computer-readable medium of clause 95, wherein the wireless device includes one or more microphones, and wherein the computer-executable instructions that, when executed by the network entity, cause the network entity to transmit the one or more navigation commands using a signaling protocol supported by the wireless device comprise computer-executable instructions to instruct at least one infrastructure speaker to transmit the navigation commands using a signaling protocol using sound waves, and further comprising computer-executable instructions that, when executed by the network entity, cause the network entity to: establish a connection with the wireless device using sound wave signaling, RF signaling, or a combination thereof.

Clause 97. The non-transitory computer-readable medium of any of clauses 85 to 96, further comprising computer-executable instructions that, when executed by the network entity, cause the network entity to: obtain information indicative of a detected or predicted navigation impediment for at least one impeded route segment included in a remaining portion of the first route, subsequent to transmitting at least one of the one or more navigation commands for the first route to the wireless device, one or more infrastructure devices, or the combination thereof and at a subsequent position of the wireless device; obtain information indicative of a navigation environment and information indicative of an estimated traversal distance for a plurality of potential routes from the subsequent position of the wireless device to the one or more locations proximate the one or more target assets; and select a second route to the first location proximate the first target asset based at least in part on the information indicative of the navigation environment and the information indicative of the estimated traversal distance for the plurality of potential routes from the subsequent position of the wireless device to the first location proximate the first target asset, the second route not including the at least one impeded route segment.

Clause 98. The non-transitory computer-readable medium of any of clauses 85 to 97, further comprising computer-executable instructions that, when executed by the network entity, cause the network entity to: determine that the wireless device has deviated from the first route, subsequent to transmitting the one or more navigation commands for the first route to the wireless device, one or more infrastructure devices, or the combination thereof; and transmit one or more corrective navigation commands to the wireless device, one or more infrastructure devices, or a combination thereof.

Clause 99. The non-transitory computer-readable medium of any of clauses 85 to 98, further comprising computer-executable instructions that, when executed by the network entity, cause the network entity to: obtain an updated target asset list subsequent to transmitting the one or more navigation commands for the first route to the wireless device, one or more infrastructure devices, or the combination thereof; obtain updated information indicative of the navigation environment and information indicative of an estimated traversal distance for one or more potential routes based at least in part on the updated target asset list; and use the updated target asset list, the updated information indicative of the navigation environment for the one or more potential routes, and the information indicative of the estimated traversal distance for the one or more potential routes to select a second route, wherein the second route includes at least one different route segment than a remaining portion of the first route.

Clause 100. The non-transitory computer-readable medium of any of clauses 85 to 99, further comprising computer-executable instructions that, when executed by the network entity, cause the network entity to: detect a position of the wireless device proximate the first target asset; and transmit one or more retrieval commands to the wireless device, one or more infrastructure devices, or a combination thereof.

Clause 101. The non-transitory computer-readable medium of clause 100, wherein the wireless device is associated with a visually impaired user, and wherein the one or more retrieval commands comprise commands to generate user movement instructions at the wireless device, one or more infrastructure devices, or a combination thereof.

Clause 102. The non-transitory computer-readable medium of clause 101, further comprising computer-executable instructions that, when executed by the network entity, cause the network entity to: receive RF data, image data, audio data, or a combination thereof indicating user position information in response to the user movement instructions; and transmit one or more additional retrieval commands to the wireless device, one or more infrastructure devices, or the combination thereof based at least in part on the user position information.

Clause 103. The non-transitory computer-readable medium of any of clauses 100 to 102, further comprising computer-executable instructions that, when executed by the network entity, cause the network entity to: determine a successful retrieval of the first target asset or an erroneous retrieval of a different asset; and transmit an indication of the successful retrieval or the erroneous retrieval to the wireless device, one or more infrastructure devices, or a combination thereof.

Clause 104. The non-transitory computer-readable medium of any of clauses 85 to 90 and 92 to 103, further comprising computer-executable instructions that, when executed by the network entity, cause the network entity to: associate a user identifier to a visually impaired person without a device configured to communicate with the network entity; associate the user identifier with a detectable user characteristic, the user characteristic detectable by image data, audio data, RF data, haptic data, sensor data, or a combination thereof; detect the user characteristic using image data, audio data, RF data, haptic data, sensor data, or a combination thereof received from at least one infrastructure device; and determine a position of the visually impaired person based at least in part on detecting the user characteristic.

Clause 105. A non-transitory computer-readable medium storing computer-executable instructions that, when executed by a wireless device, cause the wireless device to: communicate with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user; receive at least a first navigation command indicative of a first route from the network entity, the first route including a plurality of route segments from an initial location of the wireless device to a target location, wherein the target location is based at least in part on at least a first target asset; and generate a first navigation instruction comprising haptic output, audio output, or both, the first navigation instruction determined based at least in part on a first navigation command.

Clause 106. The non-transitory computer-readable medium of clause 105, further comprising computer-executable instructions that, when executed by the wireless device, cause the wireless device to: subsequently generate a second navigation instruction comprising haptic output, audio output, or both, the second navigation instruction based at least in part on a second navigation command indicative of the first route; receive one or more navigation commands indicative of an updated route to the target location during navigation of a route segment based at least in part on the second navigation instruction; and generate one or more corrective navigation instructions comprising haptic output, audio output or both, the one or more corrective navigation instructions based at least in part on the one or more navigation commands indicative of the updated route.

Clause 107. The non-transitory computer-readable medium of clause 106, wherein the one or more corrective navigation instructions comprise one or more instructions to correct an error in executing the second navigation instruction.

Clause 108. The non-transitory computer-readable medium of any of clauses 106 to 107, wherein the one or more corrective navigation instructions comprise one or more instructions for a second different route from a current location to the target location, the second different route differing in at least one route segment from a remaining portion of the first route.

Clause 109. The non-transitory computer-readable medium of any of clauses 105 to 108, further comprising computer-executable instructions that, when executed by the wireless device, cause the wireless device to: transmit detected RF data, image data, audio data, or a combination thereof to the network entity directly or via one or more infrastructure devices or both, the RF data image data, audio data, or both detected during navigation to the target location.

Clause 110. The non-transitory computer-readable medium of any of clauses 105 to 109, wherein the wireless device comprises a cellular phone, a cane, a mobility cart, a mobility device, a camera, a speaker, a microphone, a haptic device, a visual assistance device, or a combination thereof.

Clause 111. The non-transitory computer-readable medium of any of clauses 105 to 110, further comprising computer-executable instructions that, when executed by the wireless device, cause the wireless device to: generate an indication that the wireless device is positioned proximate the first target asset; and generate one or more retrieval instructions comprising haptic output, audio output, or both.

Clause 112. The non-transitory computer-readable medium of clause 111, further comprising computer-executable instructions that, when executed by the wireless device, cause the wireless device to: detect a successful retrieval of the first target asset or an erroneous retrieval of an asset different than the first target asset; generate one or more navigation instructions to a second target location; or generate an indication of the erroneous retrieval, generating updated retrieval instructions, or a combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Claim elements of the form “A, B, or a combination thereof” encompass one or more A, one or more B, or combinations of A and B. Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A network entity, comprising:
one or more memories;
one or more transceivers; and
one or more processors communicatively coupled to the one or more memories and the one or more transceivers, the one or more processors, either alone or in combination, configured to:
obtain information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes;
select a first route from the initial position of the wireless device to at least a first location of the one or more locations based at least in part on the information indicative of the navigation environment and the information indicative of the estimated traversal distance, the first location proximate a first target asset of the one or more target assets; and
transmit, via the one or more transceivers, one or more navigation commands for the first route to the wireless device, one or more infrastructure devices, or a combination thereof.

2. The network entity of claim 1, wherein the one or more processors, either alone or in combination, are further configured to process the image data to detect or predict one or more navigation impediments.

3. The network entity of claim 1, wherein, to use the information indicative of the navigation environment to select the first route, the one or more processors, either alone or in combination, are further configured to detect or predict a navigation impediment in an impeded segment of a non-selected route of the plurality of potential routes, wherein the non-selected route is shorter than the first route.

4. The network entity of claim 1, wherein, to obtain the image data from the one or more cameras positioned to monitor the one or more segments of the plurality of potential routes, the one or more processors, either alone or in combination, are configured to receive image data obtained by one or more infrastructure devices, one or more mobile devices, or both, and further configured to:
detect or predict one or more navigation impediments based at least in part on the image data; and
obtain updated information indicative of the navigation environment recurrently, based at least in part on an occurrence of an event, based at least in part on a schedule, or a combination thereof.

5. The network entity of claim 1, wherein, to obtain the information indicative of the navigation environment for the plurality of potential routes, the one or more processors, either alone or in combination, are configured to receive audio data obtained by one or more audio infrastructure devices, one or more mobile devices, or both, and further configured to:
detect or predict one or more navigation impediments based at least in part on the audio data; and
obtain updated information indicative of the navigation environment recurrently, based on an occurrence of an event, based at least in part on a schedule, or a combination thereof.

6. The network entity of claim 1, wherein the wireless device is associated with a visually impaired user, and wherein the one or more processors are further configured to:
obtain information indicative of one or more capabilities of the wireless device, a battery status of the wireless device, a medium access control (MAC) address of the wireless device, a radiofrequency (RF) status of the wireless device, or a combination thereof; and
establish a connection with the wireless device.

7. The network entity of claim 1, wherein the wireless device is included in an automated guided vehicle (AGV).

8. The network entity of claim 1, wherein the wireless device is associated with a visually impaired user and comprises a device integrated with a mobility cart, a device integrated with a mobility aid, a device with one or more speakers, a device with one or more microphones, a device with one or more cameras, a device with vibration capability, or a combination thereof.

9. The network entity of claim 1, wherein a detectable user characteristic is associated with a user identifier of the wireless device, wherein the user characteristic is detectable by image data, audio data, RF data, or a combination thereof, and wherein the one or more processors, either alone or in combination, are further configured to:
detect the user characteristic using image data, audio data, RF data or the combination thereof received from at least one infrastructure device; and
determine a position of the wireless device based at least in part on detecting the user characteristic.

10. The network entity of claim 1, wherein the one or more processors, either alone or in combination, are further configured to:
determine a set of navigation commands for the first route, the set of navigation commands including the one or more navigation commands for the first route; and
wherein, to transmit the one or more navigation commands for the first route to the wireless device, one or more infrastructure devices, or the combination thereof, the one or more processors, either alone or in combination, are configured to transmit the one or more navigation commands sequentially.

11. The network entity of claim 10, wherein, to determine the set of navigation commands, the one or more processors, either alone or in combination, are configured to select the set of navigation commands based at least in part on one or more wireless device capabilities, and further configured to transmit the one or more navigation commands to the wireless device using a signaling protocol supported by the wireless device.

12. The network entity of claim 11, wherein the wireless device includes one or more microphones, and wherein the one or more processors, either alone or in combination, are configured to transmit the one or more navigation commands using a signaling protocol supported by the wireless device by instructing at least one infrastructure speaker to transmit the navigation commands using a signaling protocol using sound waves, and are further configured to:
establish a connection with the wireless device using sound wave signaling, RF signaling, or a combination thereof.

13. The network entity of claim 1, wherein the one or more processors, either alone or in combination, are further configured to:
obtain information indicative of a detected or predicted navigation impediment for at least one impeded route segment included in a remaining portion of the first route, subsequent to transmitting at least one of the one or more navigation commands for the first route to the wireless device, one or more infrastructure devices, or the combination thereof and at a subsequent position of the wireless device;
obtain information indicative of a navigation environment and information indicative of an estimated traversal distance for a plurality of potential routes from the subsequent position of the wireless device to the one or more locations proximate the one or more target assets; and
select a second route to the first location proximate the first target asset based at least in part on the information indicative of the navigation environment and the information indicative of the estimated traversal distance for the plurality of potential routes from the subsequent position of the wireless device to the first location proximate the first target asset, the second route not including the at least one impeded route segment.

14. The network entity of claim 1, wherein the one or more processors, either alone or in combination, are further configured to:
determine that the wireless device has deviated from the first route, subsequent to transmitting the one or more navigation commands for the first route to the wireless device, one or more infrastructure devices, or the combination thereof; and
transmit one or more corrective navigation commands to the wireless device, one or more infrastructure devices, or a combination thereof.

15. The network entity of claim 1, wherein the one or more processors, either alone or in combination, are further configured to:
obtain an updated target asset list subsequent to transmitting the one or more navigation commands for the first route to the wireless device, one or more infrastructure devices, or the combination thereof;
obtain updated information indicative of the navigation environment and information indicative of an estimated traversal distance for one or more potential routes based at least in part on the updated target asset list; and
use the updated target asset list, the updated information indicative of the navigation environment for the one or more potential routes, and the information indicative of the estimated traversal distance for the one or more potential routes to select a second route, wherein the second route includes at least one different route segment than a remaining portion of the first route.

16. The network entity of claim 1, wherein the one or more processors, either alone or in combination, are further configured to:
detect a position of the wireless device proximate the first target asset; and
transmit, via the one or more transceivers, one or more retrieval commands to the wireless device, one or more infrastructure devices, or a combination thereof.

17. The network entity of claim 16, wherein the wireless device is associated with a visually impaired user, and wherein the one or more retrieval commands comprise commands to generate user movement instructions at the wireless device, one or more infrastructure devices, or a combination thereof.

18. The network entity of claim 17, wherein the one or more processors, either alone or in combination, are further configured to:
receive, via the one or more transceivers, RF data, image data, audio data, or a combination thereof indicating user position information in response to the user movement instructions; and
transmit, via the one or more transceivers, one or more additional retrieval commands to the wireless device, one or more infrastructure devices, or the combination thereof based at least in part on the user position information.

19. The network entity of claim 16, wherein the one or more processors, either alone or in combination, are further configured to:
determine a successful retrieval of the first target asset or an erroneous retrieval of a different asset; and
transmit, via the one or more transceivers, an indication of the successful retrieval or the erroneous retrieval to the wireless device, one or more infrastructure devices, or a combination thereof.

20. The network entity of claim 1, wherein the one or more processors, either alone or in combination, are further configured to:
associate a user identifier to a visually impaired person without a device configured to communicate with the network entity;
associate the user identifier with a detectable user characteristic, the user characteristic detectable by image data, audio data, RF data, haptic data, sensor data, or a combination thereof;
detect the user characteristic using image data, audio data, RF data, haptic data, sensor data, or a combination thereof received from at least one infrastructure device; and
determine a position of the visually impaired person based at least in part on detecting the user characteristic.

21. A wireless device, comprising:
one or more memories;
one or more transceivers; and
one or more processors communicatively coupled to the one or more memories and the one or more transceivers, the one or more processors, either alone or in combination, configured to:
communicate, via the one or more transceivers, with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user;
receive, via the one or more transceivers, at least a first navigation command indicative of a first route from the network entity, the first route including a plurality of route segments from an initial location of the wireless device to a target location, wherein the target location is based at least in part on at least a first target asset; and
generate a first navigation instruction comprising haptic output, audio output, or both, the first navigation instruction determined based at least in part on a first navigation command.

22. The wireless device of claim 21, wherein the one or more processors, either alone or in combination, are further configured to:
subsequently generate a second navigation instruction comprising haptic output, audio output, or both, the second navigation instruction based at least in part on a second navigation command indicative of the first route;
receive one or more navigation commands indicative of an updated route to the target location during navigation of a route segment based at least in part on the second navigation instruction; and
generate one or more corrective navigation instructions comprising haptic output, audio output or both, the one or more corrective navigation instructions based at least in part on the one or more navigation commands indicative of the updated route.

23. The wireless device of claim 22, wherein the one or more corrective navigation instructions comprise one or more instructions to correct an error in executing the second navigation instruction.

24. The wireless device of claim 22, wherein the one or more corrective navigation instructions comprise one or more instructions for a second different route from a current location to the target location, the second different route differing in at least one route segment from a remaining portion of the first route.

25. The wireless device of claim 21, wherein the one or more processors, either alone or in combination, are further configured to:
transmit, via the one or more transceivers, detected RF data, image data, audio data, or a combination thereof to the network entity directly or via one or more infrastructure devices or both, the RF data image data, audio data, or both detected during navigation to the target location.

26. The wireless device of claim 21, wherein the wireless device comprises a cellular phone, a cane, a mobility cart, a mobility device, a camera, a speaker, a microphone, a haptic device, a visual assistance device, or a combination thereof.

27. The wireless device of claim 21, wherein the one or more processors, either alone or in combination, are further configured to:
generate an indication that the wireless device is positioned proximate the first target asset; and
generate one or more retrieval instructions comprising haptic output, audio output, or both.

28. The wireless device of claim 27, wherein the one or more processors, either alone or in combination, are further configured to:
detect a successful retrieval of the first target asset or an erroneous retrieval of an asset different than the first target asset;
in response to detecting the successful retrieval of the first target asset, generate one or more navigation instructions to a second target location; or
in response to detecting erroneous retrieval of an asset different than the first target asset, generate an indication of the erroneous retrieval, generating updated retrieval instructions, or a combination thereof.

29. A method of communication at a network entity, comprising:
obtaining information indicative of a navigation environment and information indicative of an estimated traversal distance for a plurality of potential routes from an initial position of a wireless device to one or more locations proximate one or more target assets, wherein obtaining information indicative of the navigation environment for the plurality of potential routes comprises obtaining image data from one or more cameras positioned to monitor one or more segments of the plurality of potential routes;
selecting a first route from the initial position of the wireless device to at least a first location of the one or more locations based at least in part on the information indicative of the navigation environment and the information indicative of the estimated traversal distance, the first location proximate a first target asset of the one or more target assets; and
transmitting one or more navigation commands for the first route to the wireless device, one or more infrastructure devices, or a combination thereof.

30. A method of communication at a wireless device, comprising:
communicating with a network entity using a Radio Frequency (RF) connection, an audio connection, or both, the network entity configured to manage navigation of the wireless device, wherein the wireless device is configured to receive navigation commands from the network entity and generate navigation instructions for a visually impaired user;
receiving at least a first navigation command indicative of a first route from the network entity, the first route including a plurality of route segments from an initial location of the wireless device to a target location, wherein the target location is based at least in part on at least a first target asset; and
generating a first navigation instruction comprising haptic output, audio output, or both, the first navigation instruction determined based at least in part on a first navigation command.
